(19) United States
(12) Patent Application Publication
(10) Pub. No.: US 2023/0308250 A1
(43) Pub. Date: Sep. 28, 2023

(54) MANAGING CELLULAR RADIO ACCESS TECHNOLOGY OPERATIONS

(71) Applicant: GOOGLE LLC, Mountain View, CA (US)

(72) Inventor: Chih-Hsiang Wu, Taoyuan City (TW)

(21) Appl. No.: 18/017,830

(22) PCT Filed: Jul. 23, 2021
(86) PCT No.: PCT/US2021/042869

§ 371 Date: Jan. 24, 2023

Related U.S. Application Data
(60) Provisional application No. 63/057,354, filed on Jul. 28, 2020.

(51) Int. Cl. H04L 5/00; H04W 72/0453

(52) U.S. Cl. CPC H04L 5/0096; H04W 72/0453; H04W 84/042

(57) ABSTRACT

To manage cellular radio access technology operations, a UE that is configured to support a certain functionality for communicating with a radio access network (RAN) receives (1702), from the RAN, first information indicating that the RAN supports the functionality, receives (1704), from the RAN, second information, determines (1706) based on the second information that the UE and the RAN cannot utilize the functionality, and in response to the determining, prevents (1708) activating the functionality.

### FIELD OF THE DISCLOSURE

This disclosure relates generally to wireless communications and, more particularly, to managing multi-connectivity operations and other functionalities.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

UEs can use several types of SRBs and DRBs. When operating in dual connectivity (DC), the cells associated with the base station operating as the master node (MN) define a master cell group (MCG), and the cells associated with the base station operating as the secondary node (SN) define the secondary cell group (SCG). So-called SRB1 resources carry RRC messages, which in some cases include NAS messages over the dedicated control channel (DCCH), and SRB2 resources support RRC messages that include logged measurement information or NAS messages, also over the DCCH but with lower priority than SRB1 resources. More generally, SRB1 and SRB2 resources allow the UE and the MN to exchange RRC messages related to the MN and embed RRC messages related to the SN, and also can be referred to as MCG SRBs. SRB3 resources allow the UE and the SN to exchange RRC messages related to the SN, and can be referred to as SCG SRBs. Split SRBs allow the UE to exchange RRC messages directly with the MN via lower layer resources of the MN and the SN. Further, DRBs terminated at the MN and using the lower-layer resources of only the MN can be referred as MCG DRBs, DRBs terminated at the SN and using the lower-layer resources of only the SN can be referred as SCG DRBs, and DRBs terminated at the MCG but using the lower-layer resources of the MN, the SN, or both the MN and the SN can be referred to as split DRBs.

The UE in some scenarios can concurrently utilize resources of multiple nodes (e.g., base stations or components of a distributed base station) of a radio access network (RAN), interconnected by a backhaul. In these scenarios, the UE is considered to be operating in multi-connectivity (MC) with the multiple nodes. For example, when the UE concurrently utilizes resources of two network nodes, the UE is considered to be operating in dual connectivity with the two network nodes. When these network nodes support different radio access technologies (RATs), such as 5G NR and EUTRA, this type of connectivity is referred to as Multi-Radio Dual Connectivity (MR-DC). When a UE operates in MR-DC, one base station operates as the MN that covers a primary cell (PCell), and the other base station operates as the SN that covers a primary secondary cell (PSCell). The UE communicates with the MN (via the PCell) and the SN (via the PSCell). In other scenarios, the UE utilizes resources of one base station at a time. One base station and/or the UE determines that the UE should establish a radio connection with another base station. For example, one base station can determine to hand the UE over to the second base station, and initiate a handover procedure. The UE in other scenarios can concurrently utilize resources of a RAN node (e.g., a single base station or a component of a distributed base station), interconnected to other network elements by a backhaul.

The MN can provide a control-plane connection and a user-plane connection to a core network (CN), whereas the SN generally provides a user-plane connection. A base station (e.g., MN, SN) and/or the CN in some cases causes the UE to transition from one state of the RRC protocol to another state. More particularly, the UE can operate in an idle state (e.g., EUTRA-RRC_IDLE, NR-RRC IDLE), in which the UE does not have a radio connection with a base station; a connected state (e.g., EUTRA-RRC_CONNECTED, NR-RRC CONNECTED), in which the UE has a radio connection with the base station; or an inactive state (e.g., EUTRA-RRC INACTIVE, NR-RRC INACTIVE), in which the UE has a suspended radio connection with the base station.

In some scenarios, a UE can operate in the inactive state and subsequently transition to the connected state. Generally speaking, in the inactive state, the radio connection between the UE and the radio access network (RAN) is suspended. Later, when the UE is triggered to send data (e.g., outgoing phone call, browser launch), the UE can then transition to the connected state. To carry out the transition, the UE can request that the MN establish a radio connection (e.g., by sending an RRC request message to the MN) or resume the suspended radio connection (e.g., by sending an RRC Resume Request message to the MN), so that the MN can configure the UE to operate in the connected state. After the UE transitions to the connected state, the MN can coordinate a DC operation for the UE, so that the UE can operate in DC with the MN and an SN. During the DC operation, the MN requests for an SN configuration from the SN (e.g., via an SN Addition Request message), and subsequently provides the SN configuration to the UE (e.g., via an SN RRC reconfiguration message). If the UE does not detect SCG failure after receiving the SN configuration, the UE can communicate in DC with the MN and the SN by using configuration parameters in the SN configuration.

However, a UE may fail to communicate with a RAN when the UE supports a certain technology (e.g., a certain RAT, a certain generation of a core network) but cannot interact properly with some of the network nodes of the RAN that conform to that technology. For example, an SN that performs certain functions of 5G with a UE can fail in ways unexpected by the UE, so-called an inter-operability problem. Moreover, in some cases the MN can continue to select the same SN in an attempt to provide DC to the UE, thereby causing multiple instances of an SCG failure.

Further, a UE in some cases does not correctively indicate its ability to provide functionality of a certain RAT or generation of technology. For example, the UE may receive an indication that the network supports a certain generation of technology (e.g., 5G) in a broadcast from the network and display a corresponding indicator, even though the UE cannot provide certain functionality on the particular frequency band in which a base station operates.

### SUMMARY

Generally speaking, a UE capable of communicating with a network implements the techniques of this disclosure. Using these techniques, for example, a UE that supports one or more functionalities (e.g., MC, carrier aggregation (CA), Multiple Input Multiple Output (MIMO), power saving) pursuant to a certain RAT or generation of technology (e.g., 5G) can receive system information broadcasted by a RAN that indicates that the RAN also supports the same RAT or generation of technology (e.g., 5G). Before the UE connects with this particular RAN, the UE compares the system information with information stored in the UE (e.g., in a list or other suitable record-keeping mechanism) that indicates public land mobile networks (PLMNs) or particular frequency band combinations supported by the UE. Based on the comparison, if the UE determines that the RAN belongs to any of the listed PLMNs or operates within any of the listed frequency band combinations, the UE can proceed to communicate with the RAN according to one or more functionalities pursuant to the RAT or generation of technology supported by both the UE and the RAN. More particularly, if the UE determines that the RAN belongs to any of the listed PLMNs or operates within any of the listed frequency band combinations, the UE is aware that the one or more functionalities pursuant to the RAT have been inter-operably tested between the UE and RAN to ensure that the one or more functionalities can work properly at the UE and RAN. In this way, the UE avoids failing to communicate with a RAN by using one or more incompatible functionalities, while associated with the same RAT or generation of technology supported by the UE, resulting in less communication failure and improved network efficiencies.

Furthermore, after the UE determines that the RAN belongs to any of the listed PLMNs or operates within any of the listed frequency band combinations based on the comparison described above, the UE can proceed to display an indicator of the RAT or generation of technology supported by the RAN and the UE. For example, if an SN of the RAN operates on a particular NR frequency band included in the list, the UE can proceed to display an indication that the UE supports NR, such as a 5G indicator. In this way, the UE avoids erroneously displaying a RAT or generation of technology corresponding to a RAN when the UE cannot provide certain functionality on the particular frequency bands in which the RAN operates. This is particularly advantageous in scenarios in which a UE receives, from a RAN, an upperLayerIndication field included in the system information that indicates that the RAN can operate MC for UEs, for example. Rather than relying on the upperLayerIndication field to erroneously display a 5G indicator automatically even when the UE does not support the particular NR frequency bands of the RAN for MC, the UE can verify that the NR frequency bands are unsupported, and prevent the display of the 5G indicator.

An example embodiment of these techniques is a method in a UE configured to support a functionality for communicating with a radio access network (RAN). The method is implemented using processing hardware and includes receiving, from the RAN, first information indicating that the RAN supports the functionality; receiving, by the one or more processors and from the RAN, second information; determining, based on the second information that the UE and the RAN cannot utilize the functionality; and in response to the determining, preventing the UE from activating the functionality.

Another embodiment of these techniques is a UE including processing hardware and configured to implement one of methods above.

### BRIEF DESCRIPTION OF THE DRAWINGS

FIG. 1A is a block diagram of an example system in which a RAN and a UE can implement the techniques of this disclosure for managing MC operations and other functionalities;

FIG. 1B is a block diagram of an example base station in which a centralized unit (CU) and a distributed unit (DU) can operate in the system of FIG. 1A;

FIG. 2 is a block diagram of an example protocol stack, according to which the UE of FIG. 1A can communicate with base stations of FIG. 1A;

FIG. 3 is a block diagram of an example protocol stack and processing hardware, according to which the UE of FIG. 1A can communicate with base stations of FIG. 1A.

FIG. 4A is a messaging diagram of an example scenario in which a UE of FIG. 1A verifies, based on PLMN information broadcasted from the RAN, whether the UE and RAN support MC to engage in an MC operation with the RAN;

FIG. 4B is a messaging diagram of an example scenario in which a UE of FIG. 1A verifies, based on frequency band information broadcasted from the RAN, whether the UE and RAN support MC to engage in an MC operation with the RAN;

FIG. 5A is a messaging diagram of an example scenario in which a UE of FIG. 1A verifies, based on PLMN information broadcasted from the RAN, whether the UE and RAN support MC to display an indication of the RAT supported by the RAN;

FIG. 5B is a messaging diagram of an example scenario in which a UE of FIG. 1A verifies, based on MN frequency band information broadcasted from the RAN, whether the UE and RAN support MC to display an indication of the RAT supported by the RAN;

FIG. 5C is a messaging diagram of an example scenario in which a UE of FIG. 1A verifies, based on SN frequency band information broadcasted from the RAN, whether the UE and RAN support MC to display an indication of the RAT supported by the RAN;

FIG. 6 is a messaging diagram of an example scenario in which a UE of FIG. 1A verifies, based on frequency band information broadcasted from the RAN, whether the UE and RAN support CA to display an indication of the RAT supported by the RAN;

FIG. 7 is a messaging diagram of an example scenario in which a RAN of FIG. 1A broadcasts frequency information to the UE;

FIG. 8A is a messaging diagram of an example scenario in which a UE of FIG. 1A disables DC capability in response to detecting SCG failure and subsequently performs an RRC connection reestablishment procedure with the RAN;

FIG. 8B is a messaging diagram of an example scenario in which a UE of FIG. 1A disables DC capability in response to detecting SCG failure and subsequently performs a NAS procedure with the RAN;

FIG. 8C is a messaging diagram of an example scenario in which a UE of FIG. 1A disables DC capability in response to detecting failure and subsequently sends failure information to the RAN;

FIG. 9 is a flow diagram of an example scenario in which a UE of FIG. 1A enables or disables DC capability in view of a DC band combination list stored at the UE;

FIG. 10 is a flow diagram of an example scenario in which a UE of FIG. 1A in idle or inactive state indicates a 4G icon or 5G icon using an EN-DC band combination list stored at the UE;

FIG. 11 is a flow diagram of an example scenario in which a UE of FIG. 1A in idle or inactive state indicates a 4G icon or 5G icon using a DC band combination list stored at the UE;

FIG. 12 is a flow diagram of an example scenario in which a UE of FIG. 1A in idle or inactive state indicates a 5G icon according to whether the UE supports operating in DC or CA with the RAN;

FIG. 13A is a flow diagram of an example scenario in which a UE of FIG. 1A in idle or inactive state indicates a 5G icon according to whether the UE is enabled to indicate 5G;

FIG. 13B correspond to flow diagrams in which a UE of FIG. 1A in idle or inactive state indicates a 5G icon based on information broadcasted from the RAN according to whether the UE is enabled to indicate 5G;

FIG. 14 is a flow diagram of an example scenario in which a UE of FIG. 1A in connected state indicates a 5G icon according to whether the UE is enabled to communicate in DC as a result of a reconfiguration;

FIG. 15A is a flow diagram of an example scenario in which a UE of FIG. 1A in connected state indicates a 5G icon according to whether the UE is enabled to communicate in DC as a result of a resume procedure;

FIG. 15B is a flow diagram of an example scenario in which a UE of FIG. 1A in connected state indicates a 5G icon according to whether the UE is enabled to communicate in DC as a result of a resume procedure and/or reconfiguration procedure;

FIG. 16 is a flow diagram of an example scenario in which a UE of FIG. 1A disables DC capability in response to detecting SCG failure; and

FIG. 17 is a flow diagram of an example method in which a UE of FIG. 1A communicates with the RAN according to a certain functionality if the functionality is supported by both the UE and the RAN.

### DETAILED DESCRIPTION OF THE DRAWINGS

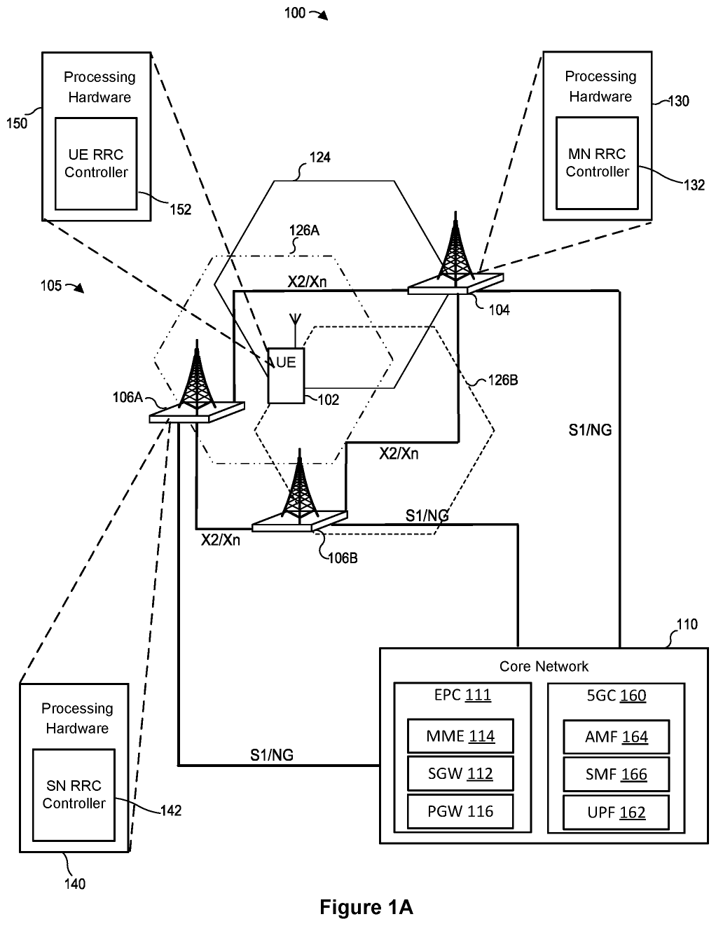

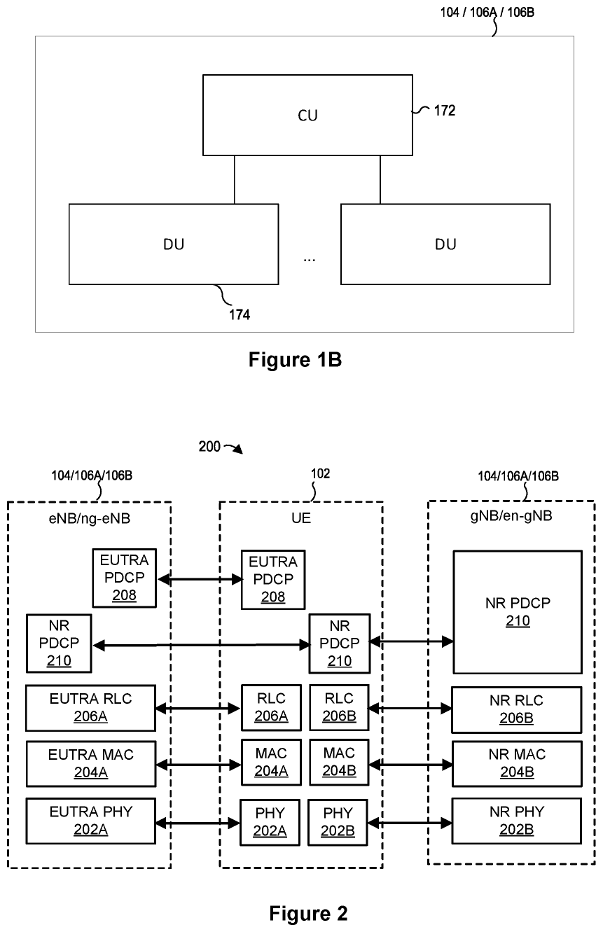

FIG. 1A depicts an example wireless communication system 100 that can implement cellular radio access technology techniques of this disclosure. The wireless communication system 100 includes a UE 102, as well as base stations 104, 106A, 106B that are connected to a core network (CN) 110. The base stations 104, 106A, 106B can operate in a RAN 105 connected to the same CN 110. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure signals from both base stations 106A or 106B, etc.). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the various MC scenarios described below. For example, the UE 102 can communicate in DC with the base station 104 (operating as an MN) and the base station 106A (operating as an SN) and, upon completing a handover, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB). In implementations and scenarios where the UE 102 is in single connectivity (SC) with the base station 104 but is capable of operating in DC, the base station 104 operates as an MeNB, an Mng-eNB, or an MgNB, and the base station 106A operates as a candidate SgNB (C-SgNB) or a candidate Sng-eNB (C-Sng-eNB). Although various scenarios are described below in which the base station 104 operates as an MN and the base station 106A (or 106B) operates as an SN or T-SN, any of the base stations 104, 106A, 106B generally can operate as an MN, an SN or a T-SN in different scenarios. Thus, in some implementations, the base station 104, the base station 106A, and the base station 106B can implement similar sets of functions and each support MN, SN, and T-SN operations.

In operation, the UE 102 can use a radio bearer (e.g., a DRB or an SRB) that at different times terminates at an MN (e.g., the base station 104) or an SN (e.g., the base station 106A). For example, after handover to the base station 106B, the UE 102 can use a radio bearer (e.g., a DRB or an SRB) that at different times terminates at the base station 106B. The UE 102 can apply one or more security keys when communicating on the radio bearer, in the uplink (from the UE 102 to a base station) and/or downlink (from a base station to the UE 102) direction.

The base station 104 includes processing hardware 130, which can include one or more general-purpose processors (e.g., central processing units (CPUs) and a computer-readable memory storing machine-readable instructions executable on the one or more general-purpose processor(s), and/or special-purpose processing units. The processing hardware 130 in the example implementation in FIG. 1A includes a base station RRC controller 132 that is configured to manage or control RRC configurations and RRC procedures. For example, the base station RRC controller 132 can be configured to support RRC messaging associated with RRC connection establishment procedures, RRC connection resume procedures, RRC connection reestablishment procedures, procedures for MC, CA, or other suitable functionalities, and/or to support the necessary operations when the base station 104 operates as an MN, as described below.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station RRC controller 142 that is configured to manage or control RRC configurations and RRC procedures. For example, the base station RRC controller 142 can be configured to support RRC messaging associated with RRC connection establishment procedures, RRC connection resume procedures, RRC connection reestablishment procedures, procedures for MC, CA, or other suitable functionalities, and/or to support the necessary operations when the base station 106A operates as an SN or target SN (T-SN), as described below. While not shown in FIG. 1A, the base station 106B can include processing hardware similar to the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE RRC controller 152 that is configured to manage or control RRC configurations and/or RRC procedures. For example, the UE RRC controller 152 can be configured to support RRC messaging associated with RRC connection establishment procedures, RRC connection resume procedures, RRC connection reestablishment procedures, and/or procedures for MC, CA, or other suitable functionalities, in accordance with any of the implementations described below.

The CN 110 can be an evolved packet core (EPC) 111 or a fifth-generation core (5GC) 160, both of which are depicted in FIG. 1A. The base station 104 can be an eNB supporting an Si interface for communicating with the EPC 111, an ng-eNB supporting an NG interface for communicating with the 5GC 160, or as a gNB that supports the NR radio interface as well as an NG interface for communicating with the 5GC 160. The base station 106A can be an EUTRA-NR DC (EN-DC) gNB (en-gNB) with an Si interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios described below, the base stations 104, 106A, and 106B can support an X2 or Xn interface.

Among other components, the EPC 111 can include a Serving Gateway (S-GW) 112, a Mobility Management Entity (MME) 114, and a Packet Data Network Gateway (P-GW) 116. The S-GW 112 is generally configured to transfer user-plane packets related to audio calls, video calls, Internet traffic, etc., and the MME 114 is configured to manage authentication, registration, paging, and other related functions. The P-GW 116 provides connectivity from the UE 102 to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same RAT, such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is a Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a centralized unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A. The processing hardware can include a base station RRC controller (e.g., RRC controller 142) configured to manage or control one or more RRC configurations and/or RRC procedures when the base station (e.g., base station 106A) operates as an SN.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as a MN or an SN. The process hardware can also include a physical layer controller configured to manage or control one or more physical layer operations or procedures.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support DC over EUTRA and NR interfaces, for example. Further, as illustrated in FIG. 2, the UE 102 can support layering of NR PDCP 210 over EUTRA RLC 206A.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.”

On a control plane, the EUTRA PDCP sublayer 208 and the NR PDCP sublayer 210 can provide SRBs to exchange RRC messages, for example. On a user plane, the EUTRA PDCP sublayer 208 and the NR PDCP sublayer 210 can provide DRBs to support data exchange.

In scenarios where the UE 102 operates in EN-DC, with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer or a split bearer. The SN-terminated bearer can be an SCG bearer or a split bearer. The MN-terminated bearer can be an SRB (e.g., SRB1 or SRB2) or a DRB. The SN-terminated bearer can be an SRB (e.g., SRB3) or a DRB.

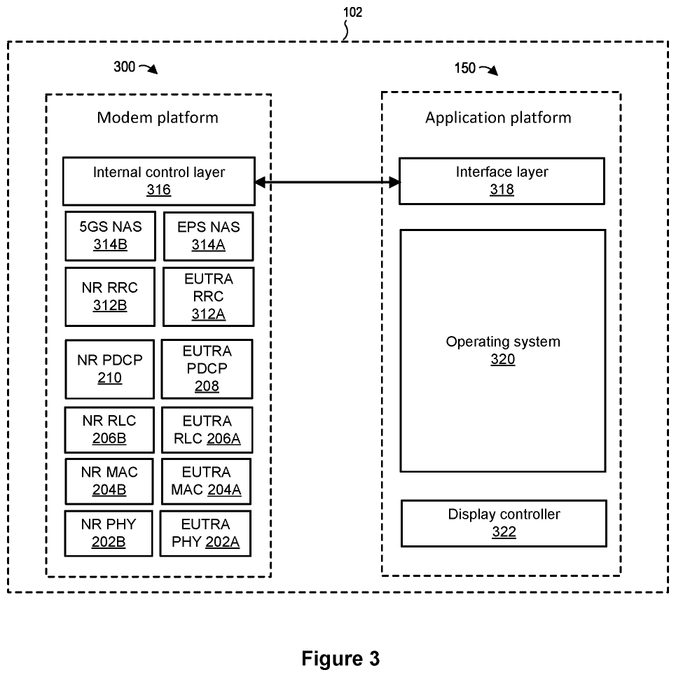

In some scenarios, the UE 102 may attach or register to the CN 110, such as EPC 111 or 5GC 160. In this disclosure, both the process of attaching to EPC 111 (which involves the EPS NAS Attach procedure specified in the 3GPP 24.301 v15.3.0 (or onwards version) document, for example) and the process of registering with 5GC 160 (which involves the 5GS NAS Registration procedure specified in the 3GPP 24.501 v15.0.0 (or onwards version) document, for example) can be understood as connecting to the corresponding core network. This connecting process may also be expanded to include future wireless core networks. In such scenarios, with reference to FIG. 3, the UE 102 can attach or register to EPC 111 or 5GC 160 using, as part of the protocol stack 300, EPS NAS 314A (layered over EUTRA RRC protocol 312A and EUTRA PDCP sublayer 208) or 5GS NAS 314B (layered over NR RRC protocol 312B and NR PDCP sublayer 210) respectively. The protocol stack 300 also can support internal control layer 316 to interface with various services and applications (e.g., via an interface layer 318) stored in processing hardware 150 (e.g., memory) of the UE 102. In some implementations, the internal control layer 316 can include a server function of remote procedure call procedures or an attention (AT) command layer, which performs functions requested by the services and applications and sends results of the performed functions, via the interface layer 318. The internal control layer 316 may include one or more sublayers in between the server function and the NAS protocol layers 314A, 314B or RRC protocol layers 312A, 312B. For example, the one or more sublayers include a connection management sublayer managing one or more lower layer protocols (e.g., NAS protocol layer 314A/B, and/or RRC protocol layer 312A/B), a data connection establishment, and/or managing which RAT(s) to be enabled or disabled.

In some scenarios, the UE 102 may display indications of RAT types (4G, 5G, 6G, etc.) supported by the RAN 105. The UE 102 can include a display controller 322 to display the indications. The display controller 322 can be implemented using any suitable combination of hardware, software, and firmware. In one example implementation, the display controller 322 is a set of instructions that defines a respective component of the operating system 320 of the UE 102, and one or more CPUs execute these instructions to perform the corresponding function.

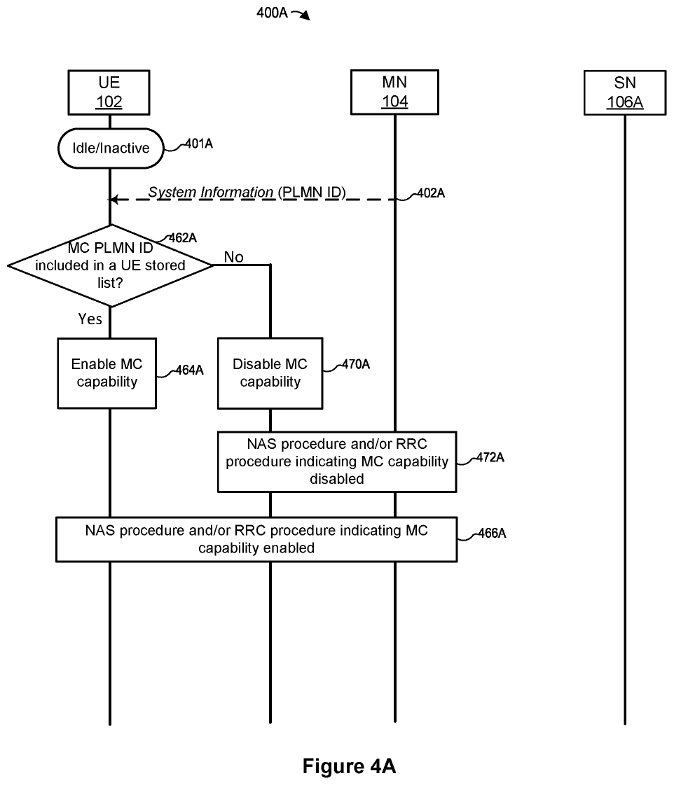

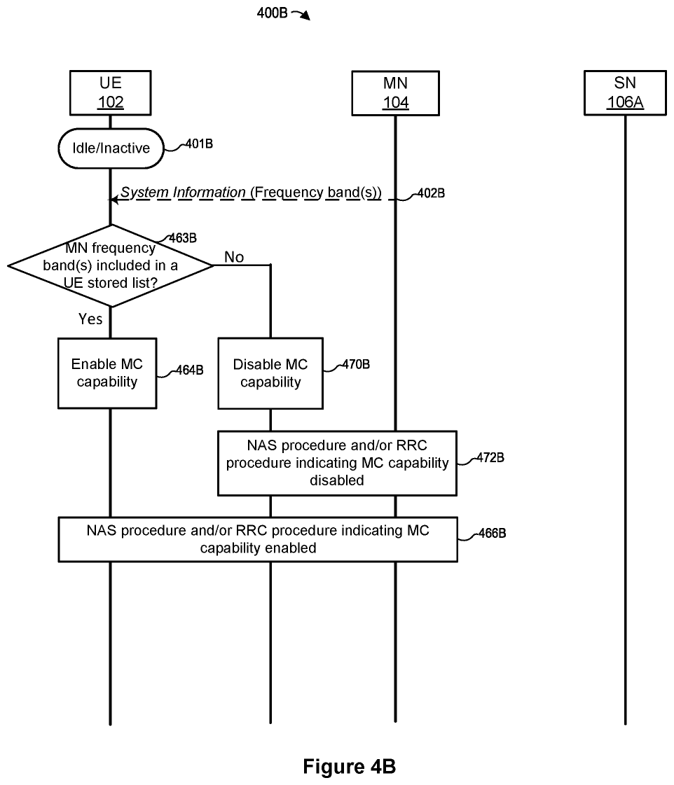

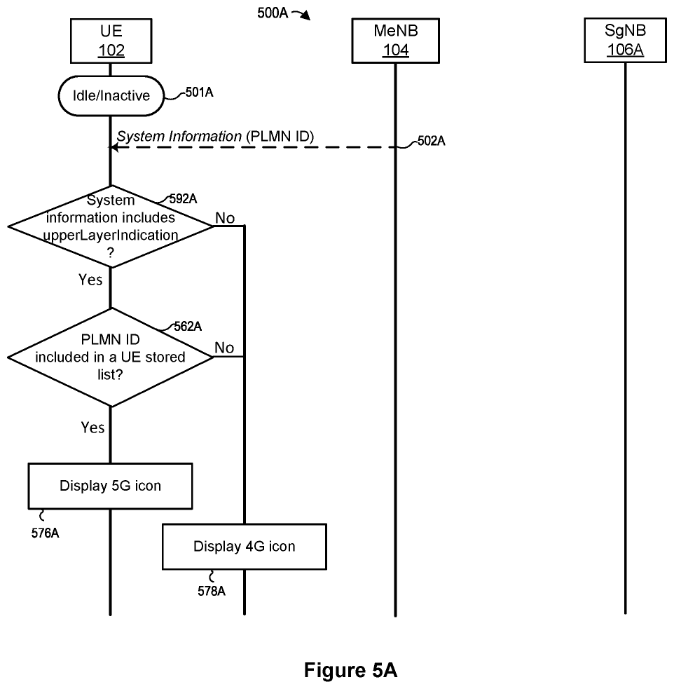

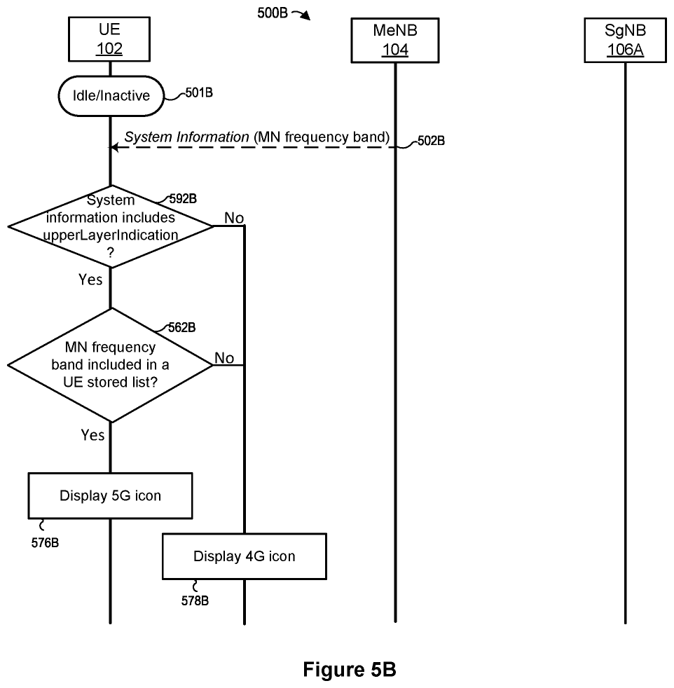

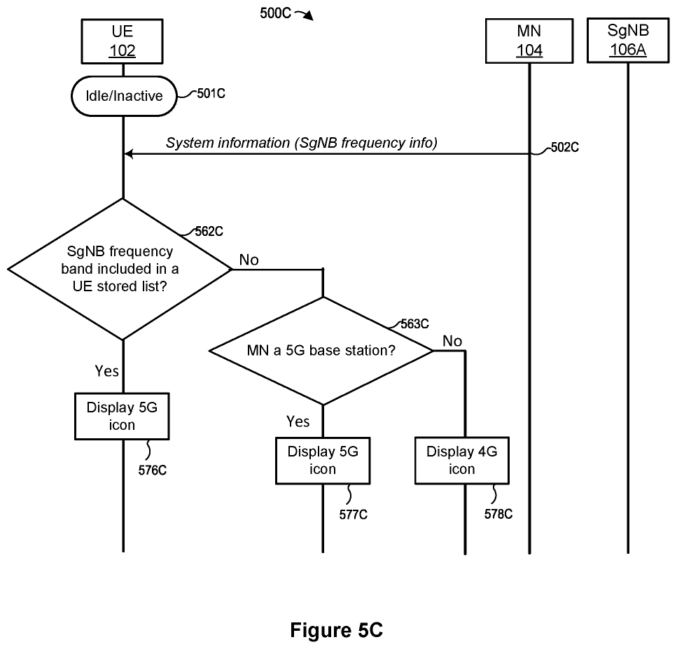

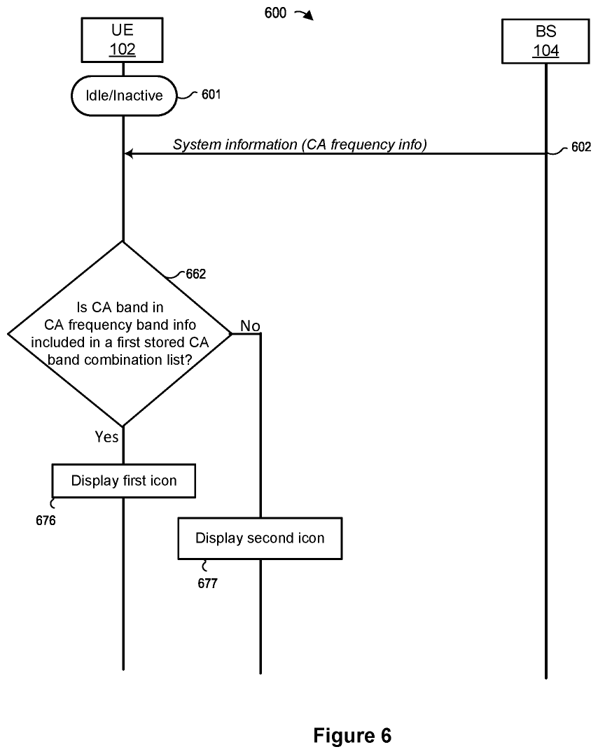

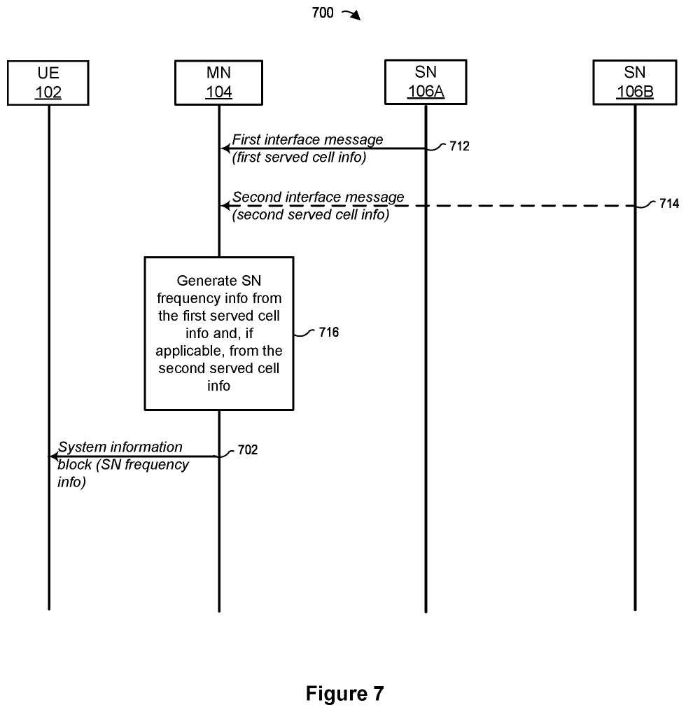

FIGS. 4A and 4B correspond to scenarios in which a UE verifies, based on information broadcasted from the RAN, whether the UE and RAN support MC using information stored at the UE, prior to engaging in an MC operation with the RAN. FIGS. 5A, 5B, 5C, and 6 correspond to scenarios in which a UE verifies, based on information broadcasted from the RAN, whether the UE and RAN support MC or CA using information stored at the UE, prior to displaying an indication of the RAT supported by the RAN when registered to the RAN. FIG. 7 corresponds to a scenario in which the RAN broadcasts frequency information to the UE. While FIGS. 4A, 4B, 5A, 5B, 5C, 6, and 7 and the accompanying descriptions refer specifically to the UE 102 and base stations 104, 106A, 106B of FIG. 1A supporting MC or CA pursuant to 5G, it is understood that the following techniques may be implemented by other components and/or in systems other than the wireless communication system 100 of FIG. 1A to support other functionalities pursuant to other technologies, such as 6G radio access and/or 6G core network, for example.

Referring first to FIG. 4A, according to a scenario 400A, the base station 104 of RAN 105 can operate as an MN and the base station 106A of RAN 105 can operate as an SN for the UE 102. The UE 102 is capable of MC operation, but not necessarily capable of operating in MC on all PLMNs.

Initially, the UE 102 operates 401A in an idle or inactive state (e.g., RRC_IDLE or RRC_INACTIVE respectively) while camping on a cell (e.g., cell 124) of the MN 104. For example, the UE 102 is powered on or switches off a flight mode to operate in the idle state.

The UE 102, while operating 401A in the idle or inactive state, receives 402A system information via the cell 124 from the MN 104. The system information can include a master information block (MIB) and/or at least one system information block (SIB), which can include SIB type 1 (SIB1) and/or SIB type 2 (SIB2). The UE 102 can use the information in the MIB to process SIB(s) that provide parameters related to access, scheduling information of other SIBs, etc. Using the SIB information, the UE 102 can proceed to network operator selection. The UE 102 can obtain from the SIB transmissions cell selection parameters including a PLMN identity or identifier (ID) of a PLMN to which RAN 105 belongs.

After receiving 402A the system information, the UE 102 determines 462A whether the PLMN ID is included in a list, database, file, or other suitable record-keeping mechanism stored in the UE 102 (e.g., a computer-readable memory of the UE 102) that designates all the PLMNs supported by the UE 102 by a corresponding PLMN ID. For example, the list may designate only the PLMNs that the UE 102 has been tested against and approved to support MC. If the UE 102 determines that the PLMN ID is included in an MC PLMN ID list, then the UE 102 can be aware that the UE 102 supports MC with the RAN 105 (i.e., MN 104 and SN 106A). In some implementations, the UE 102 can receive update information from a service provider or a UE manufacturer during an over-the-air (OTA) update, to dynamically update the information stored in the list with additional supported PLMNs, for example.

In some implementations, the UE 102 determines whether to register with the PLMN based on the PLMN ID. In one implementation, if the PLMN ID is stored in a universal subscriber identity module (USIM) in the UE 102, the UE 102 determines to register with the PLMN. For example, the PLMN ID is a home PLMN ID or included in a PLMN list in the USIM. In another implementation, the UE 102 may maintain a particular PLMN list to determine to register with a PLMN. If the PLMN ID is stored in the particular PLMN list, the UE 102 determines to register with the PLMN. In yet another implementation, the UE 102 may maintain a forbidden PLMN list. If the PLMN ID is included in the forbidden PLMN list, the UE 102 determines not to register with the PLMN. If the PLMN ID is not included in the forbidden PLMN list, the UE 102 determines to register with the PLMN. The UE 102 may make the determination at event 462A before, while, or after determining to register with the PLMN.

If the UE 102 determines 462A the PLMN ID is included in the list, the UE 102 proceeds to enable (i.e., activate) 464A MC capability (e.g., DC capability), and in response, registers with the PLMN. To register with the PLMN, the UE 102 performs 466A a NAS procedure with a CN (e.g., CN 110 as shown in FIG. 1A) and/or performs an RRC procedure with the MN 104 to indicate that MC capability has been enabled. After the UE 102 registers with the PLMN, the MN 104 can coordinate an MC operation (e.g., DC operation) with the SN 106A. Because the UE 102 supports DC with the RAN 105, the UE 102 can communicate in DC with the MN 104 and SN 106A.

Otherwise, if the UE 102 determines 462A the PLMN ID is not included in the list, the UE 102 disables (or does not activate) 470A MC capability (e.g., DC capability). In response, in some implementations, the UE 102 can still register with the PLMN by performing 472A the NAS procedure with the CN 110 and/or performing the RRC procedure with the MN 104 to indicate that MC capability has been disabled, to establish a radio connection to communicate in SC with the MN 104.

While FIG. 4A refers specifically to the UE 102 and RAN 105 supporting MC, it is understood that the techniques may be applied for CA (e.g., uplink and/or downlink CA), uplink Multiple Input Multiple Output (MIMO), or power saving techniques. The UE 102 may support downlink MIMO and/or a single DRX operation irrelevant to which PLMN the UE 102 registers with. For example, the list may designate only the PLMNs that the UE 102 has been tested against and approved to support CA. If the UE 102 determines that the PLMN ID is included in a CA PLMN ID list, then the UE 102 can be aware that the UE 102 supports CA with the RAN 105 and proceed to enable CA capability. After the UE 102 registers with the PLMN, the RAN 105 (e.g., MN 104) can coordinate a CA operation with the UE 102. In some implementations, the RAN 105 can include a CA controller to manage or control RRC messaging and RRC configurations involving CA operations, cross-carrier scheduling, activation/deactivation of secondary cells (SCells), activation/deactivation of bandwidth parts (BWP) and/or generation and transmissions of Downlink Control Information (DCI) to support the necessary CA operation.

In another example, the list may designate only the PLMNs that the UE 102 has been tested against and approved to support uplink MIMO. If the UE 102 determines that the PLMN ID is included in an uplink MIMO PLMN ID list, then the UE 102 can be aware that the UE 102 supports uplink MIMO with the RAN 105 and proceed to enable an uplink MIMO capability. After the UE 102 registers with the PLMN, the RAN 105 (e.g., MN 104) can coordinate an uplink MIMO operation with the UE 102. In yet another example, the list may designate only the PLMNs that the UE 102 has been tested against and approved to support uplink MIMO. If the UE 102 determines that the PLMN ID is included in an uplink MIMO PLMN ID list, then the UE 102 can be aware that the UE 102 supports uplink MIMO with the RAN 105 and proceed to enable the uplink MIMO capability. After the UE 102 registers with the PLMN, the RAN 105 (e.g., MN 104) can coordinate an uplink MIMO operation with the UE 102.

In some implementations, the power saving techniques described above may include wakeup signal detection, PDCCH monitoring skipping, dormant SCell operation, dormant BWP operation, or an additional discontinuous reception (DRX) operation (i.e., secondary DRX). For example, the list may designate only the PLMNs that the UE 102 has been tested against and approved to support power saving. In other implementations, the power saving techniques may include stop (e.g., disable) measuring a carrier frequency (e.g., NR carrier frequency) or stop transmitting a measurement report of the carrier frequency for enabling MC or CA operation.

In some implementations, if the UE 102 determines that the PLMN ID is included in a power saving PLMN ID list, then the UE 102 can be aware that the UE 102 supports power saving with the RAN 105 and proceed to enable a power saving capability. After the UE 102 registers with the PLMN, the RAN 105 (e.g., MN 104) can coordinate a power saving operation with the UE 102. In yet another example, the list may designate only the PLMNs that the UE 102 has been tested against and approved to support power saving. If the UE 102 determines that the PLMN ID is included in a power saving PLMN ID list, then the UE 102 can be aware that the UE 102 supports a power saving operation with the RAN 105 and proceed to enable the power saving capability. After the UE 102 registers with the PLMN, the RAN 105 (e.g., MN 104) can coordinate a power saving operation with the UE 102.

In other implementations, if the UE 102 determines that the PLMN ID is not included in a power saving disabled PLMN ID list, then the UE 102 can be aware that the UE 102 supports power saving with the RAN 105 and proceed to enable a power saving capability. After the UE 102 registers with the PLMN, the RAN 105 (e.g., MN 104) can coordinate a power saving operation with the UE 102. If the UE 102 determines that the PLMN ID is included in the power saving disabled PLMN ID list, then the UE 102 can be aware that the UE 102 does not support power saving with the RAN 105 and proceed to disable the power saving capability. After the UE 102 registers with the PLMN, the RAN 105 (e.g., MN 104) refrains from enabling the power saving operation with the UE 102.

To perform the NAS procedure described above, the UE 102 can send a NAS Request message to the CN 110 via the MN 104, the CN 110 in turn can send a NAS Accept message to the UE 102 via the MN 104, and the UE 102 in response can send a NAS Complete message to the CN 110 via the MN 104. In some implementations, the NAS procedure can be an Attach procedure, a Tracking Area Update (TAU) procedure, or a Registration procedure. In the Attach procedure, the NAS Request message, NAS Accept message, and NAS Complete message can be an Attach Request message, an Attach Accept message, and an Attach Complete message, respectively. In the TAU procedure, the NAS Request message, NAS Accept message, and NAS Complete message can be a TAU Request message, a TAU Accept message, and a TAU Complete message, respectively. In the Registration procedure, the NAS Request message, NAS Accept message, and NAS Complete message can be a Registration Request message, a Registration Accept message, and a Registration Complete message, respectively.

As described above, the UE 102 in some implementations can enable or disable DC capability in events 464A and 470A, respectively. DC can refer to EN-DC, NGEN-DC, NR-DC or NE-DC. In some implementations, if the UE 102 enables EN-DC capability, the UE 102 can set a certain bit (e.g., DCNR bit) to “dual connectivity with NR supported” or other suitable designation in the Attach Request message or TAU Request message. Upon receiving the Attach Request message or TAU Request message, the CN 110 may or may not grant the UE 102 to use EN-DC. If the CN 110 grants the UE 102 to use EN-DC, the CN 110 can set a certain bit (e.g., RestrictDCNR bit) to “use of dual connectivity with NR is not restricted” or other suitable designation in the Attach Accept message or TAU Accept message. If the CN 110 does not grant the UE 102 to use EN-DC, the CN 110 can set a certain bit (e.g., RestrictDCNR bit) to “use of dual connectivity with NR is restricted” or other suitable designation in the Attach Accept message or TAU Accept message.

In some implementations, if the UE 102 disables EN-DC capability, the UE 102 can set a certain bit (e.g., DCNR bit) to “dual connectivity with NR not supported” or other suitable designation in the Attach Request message or TAU Request message. Alternatively, the UE 102 does not include the DCNR bit in the Attach Request message or TAU Request message. In this case, upon receiving the Attach Request message or TAU Request message, the CN 110 does not grant the UE 102 to use EN-DC. The CN 110 can set a certain bit (e.g., RestrictDCNR bit) to “use of dual connectivity with NR is restricted” or other suitable designation in the Attach Accept message or TAU Accept message. Alternatively, the CN 110 may not include the RestrictDCNR bit in the Attach Request message or TAU Request message.

Similarly, in other implementations, the UE 102 may or may not indicate support of NGEN-DC, NR-DC, or NE-DC in the NAS Request message and/or NAS Complete message. Accordingly, the CN 110 may or may not grant the UE 102 to use NGEN-DC, NR-DC, or NE-DC in the NAS Accept message.

In some implementations, the RRC procedure can be a UE Capability Transfer procedure. In the UE Capability Transfer procedure, the MN 104 can transmit a UECapabilityEnquiry message to the UE 102, which in turn transmits a UECapabilityInformation message to the MN 104. If the UE 102 enables DC capability, the UE 102 can indicate that the UE 102 supports DC capability in the UECapabilityInformation message. In one implementation, the UE 102 can include an indicator indicating that the UE 102 supports DC (e.g., EN-DC, NGEN-DC, NR-DC or NE-DC) in the UECapabilityInformation message. In another implementation, the UE 102 can include supported DC band combinations in the UECapabilityInformation message. If the UE 102 disables DC capability, the UE 102 does not indicate that the UE 102 supports DC capability in the UECapabilityInformation message.

In some implementations, after the UE 102 succeeds the NAS procedure at event 466A, if the CN 110 does not restrict EN-DC for the UE 102 and the system information includes an indication (e.g., upperLayerIndication field in SIB2) indicating that the UE 102 in the cell 124 has entered a coverage area that overlaps with coverage of an SN 106A that is a 5G base station (e.g., an SgNB) that offers 5G functionalities, the UE 102 can display an indication of 5G, or other suitable indicator (e.g., NR). Otherwise, the UE 102 indicates 4G or other suitable indicator (e.g., LTE). In some implementations, the UE 102 may not indicate 5G before the UE 102 succeeds the NAS procedure 466A (e.g., the UE 102 receives an Attach Accept message). If the UE 102 disables EN-DC capability at event 470A, the UE 102 indicates 4G on the display regardless of whether the system information indicates that the UE 102 in the cell 124 has entered a coverage area that offers 5G functionalities. In some implementations, the UE 102 may not indicate 4G before the UE 102 succeeds the NAS procedure 472A (e.g., the UE 102 receives an Attach Accept message).

In some implementations, the list stored in the UE 102 may also indicate all the applicable RATs supported by each of the PLMNs. For example, if the MN 104 is a 4G base station (e.g., an MeNB) and SN 106A is a 5G base station (e.g., an SgNB), an entry in the list for the PLMN ID corresponding to the PLMN that covers the MN 104 and SN 106A may include indications of 4G and 5G, or other suitable indications (e.g., LTE, NR). After the UE 102 registers with the PLMN with DC enabled and communicates in DC with the MN 104 and SN 106A, the UE 102 can display indications of 4G, 5G, or both in accordance with the list. As another example, if an entry for the PLMN ID, which corresponds to a PLMN that covers MN 104, SN 106A (both of which are 5G base stations), and an additional 6G base station, includes indications of 5G and 6G or other suitable indications, after the UE 102 registers with the PLMN with MC capability enabled and communicates in MC with the three base stations, the UE 102 can display indications of 5G, 6G, or both in accordance with the list. Because the UE 102 in either of these examples uses the list that designates all the PLMNs supported by the UE 102 when displaying indications for the RAT(s), the UE 102 is prevented from erroneously displaying an indication of a RAT or generation of technology corresponding to a RAN that belongs to a PLMN unsupported by the UE 102 according to the list.

FIG. 4B illustrates a scenario 400B similar to the scenario 400A of FIG. 4A, in which the base station 104 of RAN 105 can operate as an MN for the UE 102, and the base station 106A of RAN 105 can operate as an SN for the UE 102. Whereas the UE 102 in FIG. 4A is capable of MC operation, but not necessarily capable of operating in MC on all PLMNs, the UE 102 in FIG. 4B is capable of MC operation, but not necessarily capable of operating in MC on all combinations of frequency bands.

As in FIG. 4A, the UE 102 initially operates 401B in an idle or inactive state while camping on a cell (e.g., cell 124) of the MN 104, similar to event 401A. While operating 401B in the idle or inactive state, the UE 102 receives 402B system information via the cell 124 from the MN 104, similar to event 402A.

Whereas the UE 102 in FIG. 4A obtains a PLMN ID from the system information and determines 462A whether the PLMN ID is included in a list that designates all the PLMNs supported by the UE 102, the UE 102 in FIG. 4B obtains an indication of a frequency band operable in the serving cell (e.g., cell 124) of the MN 104 (i.e., the MN frequency band) from the system information and determines 463B whether the MN frequency band is included in a list stored at the UE 102 that designates all the frequency bands (or combinations thereof) supported by the UE 102.

For example, the list may designate only the frequency bands that the UE 102 has been tested against and approved to support MC. If the UE 102 determines that the MN frequency band is included in a DC frequency band combination list, then the UE 102 can be aware that the UE 102 supports DC with the RAN 105 (i.e., MN 104 and SN 106A). In some implementations, the UE 102 may obtain, from the system information (e.g., SIB), SN frequency band information indicating the SN frequency band operable by the SN 106A to determine 463B whether both the MN frequency band and the SN frequency band are included as one of the combinations of frequency bands in the DC frequency band combination list. In some implementations, the UE 102 can receive update information from a service provider or a UE manufacturer during an over-the-air (OTA) update, to dynamically update the information stored in the list with additional supported frequency bands (or combinations thereof), for example.

If the UE 102 determines 463B the MN frequency band (and the SN frequency band if received in the event 402B) are included in the list, the UE 102 proceeds to enable (i.e., activate) 464B MC capability (e.g., DC capability) and perform 466B a NAS procedure and/or RRC procedure, similar to events 464A and 466A. Otherwise, if the UE 102 determines 463B the MN frequency band (and the SN frequency band if received in the event 402B) are not included in the list, the UE 102 proceeds to disable (or does not activate) 470B DC capability and perform 472B a NAS procedure and/or RRC procedure, similar to events 470A and 472A.

In some implementations, the list described above may be associated with a PLMN ID. In such implementations, the UE 102 can obtain a PLMN ID from the system information at event 402B, similar to event 402A. If the obtained PLMN ID is identical to the PLMN ID associated with the list, the UE 102 proceeds to event 463B. Otherwise, the UE 102 proceeds to event 470B. In other implementations, the UE 102 can store multiple lists, each associated with a unique PLMN ID, instead of a single list described above. In these implementations, if the PLMN ID obtained from the system information at event 402B is identical to any of the PLMN IDs associated with the multiple lists, the UE 102 proceeds to event 463B. Otherwise, the UE 102 proceeds to event 470B. The MN 104 may broadcast the PLMN ID and the indication of the frequency band in the same SIB or different SIBs.

In some implementations, the list(s) stored in the UE 102 may also indicate all the applicable RATs supported by each combination of frequency bands. For example, an entry in the list for a particular combination of frequency bands corresponding to the PLMN that covers the MN 104 (e.g., EUTRA frequency band) and SN 106A (e.g., NR frequency band) may include indications of 4G and 5G, or other suitable indications (e.g., LTE, NR). After the UE 102 registers with the PLMN with DC enabled and communicates in DC with the MN 104 and SN 106A, the UE 102 can display indications of 4G, 5G, or both in accordance with the list. As another example, if an entry in the list for a particular combination of frequency bands corresponding to the PLMN that covers MN 104, SN 106A (e.g., NR frequency band), and an additional 6G base station (e.g., 6G frequency band) includes indications of 5G and 6G or other suitable indications, after the UE 102 registers with the PLMN with MC capability enabled and communicates in MC with the three base stations, the UE 102 can display indications of 5G, 6G, or both in accordance with the list. Because the UE 102 in either of these examples uses the list(s) that designates all the combinations of frequency bands supported by the UE 102 when displaying indications for the RAT(s), the UE 102 is prevented from erroneously displaying an indication of a RAT or generation of technology corresponding to a RAN when the UE 102 cannot support particular frequency bands in which the RAN operates.

In some implementations, after the UE 102 succeeds the NAS procedure at event 466B, if the CN 110 does not restrict EN-DC for the UE 102 and the UE 102 supports the MN frequency band and the SN frequency band indicated in the system information, the UE 102 indicates 5G. Otherwise, the UE 102 indicates 4G on the display. If the UE 102 disables EN-DC capability at event 470B, the UE 102 indicates 4G on the display regardless of whether the UE 102 is physically capable of operating on the MN frequency band and the SN frequency band.

Referring now to FIG. 5A, according to a scenario 500A, the base station 104 of RAN 105 can operate as an MeNB and the base station 106A of RAN 105 can operate as an SgNB for the UE 102. The UE 102 is capable of EN-DC operation, but not necessarily capable of operating in EN-DC on all PLMNs.

As in FIG. 4A, the UE 102 initially operates 501A in an idle or inactive state (e.g., RRC_IDLE or RRC_INACTIVE respectively) while camping on a cell (e.g., cell 124) of the MeNB 104, similar to event 401A. While operating 501A in the idle or inactive state, the UE 102 receives 502A system information via the cell 124 from the MeNB 104, similar to event 402A. The UE 102 obtains a PLMN ID from the system information (e.g., SIB1) and registers to a PLMN, corresponding to the PLMN ID to which RAN 105 belongs (e.g., by performing 466A the NAS procedure and/or RRC procedure described in event 466A of FIG. 4A). In some implementations, the UE 102 enables EN-DC before, while, or upon registering with the PLMN.

The UE 102 then determines 592A whether the system information (e.g., SIB2) includes the upperLayerIndication field. As discussed above, the upperLayerIndication field can signify to the UE 102 that the RAN 105 is available for configuration of EN-DC operation within the area of cell 124. If the UE 102 determines 592A that the system information does not include the upperLayerIndication field (and thus determines that the RAN 105 is not available for configuration of EN-DC operation within the area of cell 124), the UE 102 indicates 578A the RAT supported by the MeNB 104 (i.e., 4G) on a display of the UE 102. If the UE 102 determines 592A that the system information (e.g., SIB2) includes the upperLayerIndication field, the UE 102 does not immediately indicate the RAT supported by the SgNB 106A (i.e., 5G) on a display of the UE 102 while in idle or inactive state.

Rather, the UE 102 determines 562A whether the PLMN ID (obtained from the system information) is included in a list, database, file, or other suitable record-keeping mechanism stored in the UE 102 that designates all the PLMNs supported by the UE 102 by a corresponding PLMN ID. For example, the list may designate only the PLMNs that the UE 102 has been tested against and approved to support MC (e.g., EN-DC). The list may be dynamically updatable during an over-the-air (OTA) update. If the UE 102 determines that the PLMN ID is included in the list, the UE 102 indicates 576A the more-advanced RAT supported by the MeNB 104 and SgNB (i.e., 5G) while in idle or inactive state. For example, if the UE 102 determines that the PLMN ID is included in an EN-DC PLMN ID list, then the UE 102 can be aware that the UE 102 supports EN-DC with the RAN 105 (i.e., MeNB 104 and SgNB 106A). Otherwise, the UE 102 indicates 578A the lesser advanced RAT supported by the MeNB 104 (i.e., 4G) on a display of the UE 102 while in idle or inactive state. In this way, the UE 102 avoids erroneously displaying an indication of a more-advanced RAT or generation of technology corresponding to a RAN that belongs to a PLMN unsupported by the UE 102 according to the list while in idle or inactive state.

Although FIG. 5A illustrates event 592A occurring prior to event 562A, in other implementations, events 592A and 562A may occur jointly, or event 562A may occur prior to event 592A. In the latter case, the UE 102 first determines whether the PLMN ID is included in the EN-DC PLMN list, and then evaluates 592A whether the system information includes the upperLayerIndication field prior to displaying any indications of the RAT.

In some implementations, the system information may omit operating frequency bands associated with the SgNB (i.e., SgNB frequency bands), and in other implementations, if the system information includes SgNB frequency bands, the UE 102 may ignore the SgNB frequency bands in assessing whether to indicate the RAT on the display.

In some implementations, the UE 102 can indicate the RAT supported by the RAN 105 depending on the carrier frequency, frequency ranges, or frequency bands over which the UE 102 transitions into connected state and communicates in EN-DC with the RAN 105. For example, the UE 102 can display different versions of the 5G indicator depending on whether the SgNB 106A operates within a second frequency range (FR2), e.g., 24 Ghz or higher as a mmWave base station, or within a first frequency range (FR1), e.g., sub-6 Ghz as a non-mmWave base station.

To transition into connected state, in some implementations, the UE 102 can perform an RRC connection establishment procedure or an RRC resume procedure with the MeNB 104. Particularly, in performing the RRC connection establishment procedure, the UE 102 transmits an RRC Request message (e.g., a RRCConnectionRequest or RRCSetupRequest message) to the MeNB 104, which in turn transmits an RRC Setup message (e.g., a RRCConnectionSetup or RRCSetup message) to the UE 102. In response, the UE 102 transitions to operating in the connected state and transmits an RRC Setup Complete message (e.g., a RRCConnectionSetupComplete or RRCSetupComplete message) to the MeNB 104. Alternatively, in performing the RRC connection resume procedure, the UE 102 transmits an RRC Resume Request message (e.g., a RRCConnectionResumeRequest or RRCResumeRequest message) to the MeNB 104, which in turn transmits an RRC Resume message (e.g., a RRCConnectionResume or RRCResume message) to the UE 102. In response, the UE 102 transitions to operating in the connected state and transmits an RRC Resume Complete message (e.g., a RRCConnectionResumeComplete or RRCResumeComplete message) to the MeNB 104.

After performing the RRC connection establishment or the resume procedure, the UE 102 can communicate in SC with the MeNB 104 via cell 124 and indicate the RAT supported by the MeNB 104 (i.e., 4G) on a display of the UE 102. In some implementations, the UE 102 can display a different version of the 4G indicator (e.g., 4G+, LTE+) if the UE 102 also performs a CA operation and communicates (e.g., via cell 124 and another cell(s) covered by the MeNB 104) with the MeNB 104.

In some implementations, after the UE 102 transitions to the connected state upon completion of either the RRC connection establishment procedure or resume procedure, the MeNB 104 can perform a DC configuration procedure with the SN 106A, to configure the UE 102 to operate in EN-DC with the RAN 105.

In some implementations, to perform the DC configuration procedure, the MeNB 104 transmit an RRC Reconfiguration message (e.g., a RRCConnectionReconfiguration or a RRCReconfiguration message) including a measurement configuration to the UE 102. With the measurement configuration, the MeNB 104 enables the UE 102 to measure a carrier frequency of the SgNB 106A. In response to receiving the RRC Reconfiguration message, the UE 102 transmits an RRC Reconfiguration Complete message (e.g., a RRCConnectionReconfigurationComplete or a RRCReconfigurationComplete message) to the MeNB 104. In some implementations, the MeNB 104 can transmit the measurement configuration in an RRC Resume message described above in the resume procedure instead of the RRC Reconfiguration message. In other implementations, the MeNB 104 can transmit the RRC Reconfiguration message to the UE 102 while the UE 102 was operating in a connected state prior to transitioning to operate 501A in the idle or inactive state, and the UE 102 can retain the measurement configuration included in the RRC Reconfiguration message while operating 501A in the idle or inactive state.

Pursuant to the measurement configuration, the UE 102 transmits at least one measurement report message to the MeNB 104. After receiving the measurement report message, the MN 104 sends an SN Addition Request message to the SgNB 106 to prepare DC operation for the UE 102. In some implementations, the MeNB 104 determines to prepare DC (e.g., EN-DC) for the UE 102 based on measurement result(s) included in the measurement report message(s) that are above (or below) one or more predetermined thresholds, or in response to calculating a filtered result from the measurement results that is above (or below) a predetermined threshold. In response to receiving the SN Addition Request message, the SgNB 106A sends an SN Addition Request Acknowledge message including an SN configuration to the MeNB 104, which in turn transmits an RRC Container message including the SN configuration to the UE 102. In response, the UE 102 transmits an RRC Container Response message to the MeNB 104, which in turn sends an SN Reconfiguration Complete message to the SgNB 106A to indicate that the UE 102 received the SN configuration. In some implementations, the SN configuration can be an SN RRC Reconfiguration message (e.g., RRCReconfiguration message), and the UE 102 can include an SN RRC Reconfiguration Complete message (e.g., RRCReconfigurationComplete message) in the RRC Container Response message. The MeNB 104 can include the SN RRC Reconfiguration Complete message in the SN Reconfiguration Complete message.

After receiving the SN configuration, the UE 102 in EN-DC may communicate with the SgNB 106A by using configuration parameters in the SN configuration while communicating with the MeNB 104. In some implementations, the UE 102 may perform a random access procedure with the SgNB 106A according to one or more random access configuration parameters in the SN configuration. After the SgNB 106A identifies the UE 102 in the random access procedure, the SN 106A communicates data (e.g., UL PDU and/or DL PDU) with the UE 102, as a result of a successful DC configuration procedure.

After performing the DC configuration procedure, the UE 102 can communicate in EN-DC with the MeNB 104 and SgNB 106A, and indicate the more-advanced RAT supported by the RAN (i.e., 5G) on a display of the UE 102. In some implementations, as described above, the UE 102 can display different versions of the 5G indicator depending on whether the SgNB 106A operates within FR2 (e.g., 24 Ghz or higher as a mmWave base station), or within FR1 (e.g., sub-6 Ghz as a non-mmWave base station).

While scenario 500A and the accompanying descriptions refer specifically to the UE 102, MeNB 104, and SgNB 106A in the context of EN-DC, it is understood that scenario 500A can apply to other types of DC (NGEN-DC, NR-DC or NE-DC) or MC. In some implementations, the list stored in the UE 102 may also indicate all the applicable RATs supported by each of the PLMNs. For example, if the base stations 104, 106A are both 5G base stations, and an additional base station in the RAN is a 6G base station, an entry in the list for the PLMN ID corresponding to the PLMN that covers the three base stations may include indications of 5G and 6G, or other suitable indications. After the UE 102 registers with the PLMN with MC enabled and communicates in MC with the three base stations, the UE 102 can display indications of 5G, 6G, or both in accordance with the list. Because the UE 102 uses the list that designates all the PLMNs supported by the UE 102 when displaying an indication for the RAT(s), the UE 102 is prevented from displaying an indication of a RAT or generation of technology corresponding to a RAN that belongs to a PLMN unsupported by the UE 102 according to the list.

FIG. 5B illustrates a scenario 500B similar to the scenario 500A of FIG. 5A, in which the base station 104 of RAN 105 can operate as an MeNB and the base station 106A of RAN 105 can operate as an SgNB for the UE 102. Whereas the UE 102 in FIG. 5A is capable of EN-DC operation, but not necessarily capable of operating in EN-DC on all PLMNs, the UE 102 in FIG. 5B is capable of EN-DC operation, but not necessarily capable of operating in EN-DC on all combinations of frequency bands.

As in FIG. 5A, the UE 102 initially operates 501B in an idle or inactive state (e.g., RRC_IDLE or RRC_INACTIVE respectively) while camping on a cell (e.g., cell 124) of the MeNB 104, similar to event 501A. While operating 501B in the idle or inactive state, the UE 102 receives 502B system information via the cell 124 from the MeNB 104, similar to event 502A. The UE 102 obtains a PLMN ID from the system information (e.g., SIB1) and registers to a PLMN to which RAN 105 belongs corresponding to the PLMN ID (e.g., by performing 466A the NAS procedure and/or RRC procedure described in event 466A of FIG. 4A). In some implementations, the UE 102 enables EN-DC before, while, or upon registering with the PLMN.

The UE 102 then determines 592B whether the system information (e.g., SIB2) includes the upperLayerIndication field, similar to event 592A. If the UE 102 determines 592B that the system information does not include the upperLayerIndication field (and thus determines that NR frequency bands are not available for configuration of EN-DC operation within the area of cell 124), the UE 102 indicates 578B the RAT supported by the MeNB 104 (i.e., 4G) on a display of the UE 102, similar to event 578A. If the UE 102 determines 592B that the system information (e.g., SIB2) includes the upperLayerIndication field, the UE 102 does not immediately indicate the RAT supported by the SgNB 106A (i.e., 5G) on a display of the UE 102 while in idle or inactive state.

Rather, whereas the UE 102 in FIG. 5A determines 562A whether the PLMN ID is included in a list, the UE 102 in FIG. 5B obtains an indication of a frequency band operable in the serving cell (e.g., cell 124) of the MeNB 104 (i.e., the MN frequency band) from the system information and determines 562B whether the MN frequency band is included in a list stored at the UE 102 that designates all the frequency bands (or combinations thereof) supported by the UE 102.

For example, the list may designate only the frequency bands that the UE 102 has been tested against and approved to support EN-DC. If the UE 102 determines that the MN frequency band is included in an EN-DC frequency band combination list, then the UE 102 can be aware that the UE 102 supports EN-DC with the RAN 105 (i.e., MeNB 104 and SgNB 106A). In some implementations, the UE 102 may obtain the SN frequency band of a cell of the SgNB 106A from the system information (e.g., SIB) to determine 562B whether both the MN frequency band and the SN frequency band are included as one of the combinations of frequency bands in the EN-DC frequency band combination list. The list may be dynamically updatable during an over-the-air (OTA) update.

If the UE 102 determines 562B the MN frequency band (and the SN frequency band if received in the event 502B) are included in the list, the UE 102 proceeds to display 576B a 5G indicator, similar to event 576A. Otherwise, if the UE 102 determines 562B the MN frequency band (and the SN frequency band if received in the event 402B) are not included in the list, the UE 102 proceeds to display 578B a 4G indicator, similar to event 578A.

Although FIG. 5B illustrates event 592B occurring prior to event 562B, in other implementations, events 592B and 562B may occur jointly, or event 562B may occur prior to event 592B.

In some implementations, the MeNB 104 may broadcast 502B the system information that includes 5G frequency band information for EN-DC. The 5G frequency information can include one or more 5G frequency band numbers indicating one or more 5G frequency bands operable by the SgNB 106A. If the UE 102 is configured to support communications over the 5G frequency band as designated in the system information, the UE 102 can proceed to display a 5G indicator at event 576B without performing events 592B and 562B. In implementations in which the MeNB 104 is unable to broadcast 5G frequency band information within the system information, the UE 102 relies on the upperLayerIndication field (in event 592B) and the list (event 562B), as described above, to display a 5G indicator. The MeNB 104 may broadcast the 5G frequency band information and the upperLayerIndication field in the same SIB or different SIBs.

In some implementations, the list described above may be associated with a PLMN ID. In such implementations, if the UE 102 determines that the obtained PLMN ID (at event 502B) is identical to the PLMN ID associated with the list, the UE 102 proceeds to event 562B. Otherwise, the UE 102 proceeds to event 578B. In other implementations, the UE 102 can store multiple lists, each associated with a unique PLMN ID, instead of a single list described above. In these implementations, if the obtained PLMN ID (event 502B) is identical to any of the PLMN IDs associated with the multiple lists, the UE 102 proceeds to event 562B. Otherwise, the UE 102 proceeds to event 578B. In some implementations, the UE 102 can indicate the RAT supported by the RAN 105 depending on the carrier frequency, frequency ranges, or frequency bands over which the UE 102 transitions into connected state and communicates in EN-DC with the RAN 105. For example, the UE 102 can display different versions of the 5G indicator depending on whether the SgNB 106A operates within FR2, e.g., 24 Ghz or higher as a mmWave base station, or within FR1, e.g., sub-6 Ghz as a non-mmWave base station. The MN 104 may broadcast the PLMN ID and the indication of the MN frequency band in the same SIB or different SIBs.

To transition into connected state, in some implementations, the UE 102 can perform an RRC connection establishment procedure or an RRC resume procedure with the MeNB 104. After performing the RRC connection establishment or the resume procedure, the UE 102 can communicate in SC with the MeNB 104 via cell 124 and indicate the RAT supported by the MeNB 104 (i.e., 4G) on a display of the UE 102. In some implementations, the UE 102 can display a different version of the 4G indicator if the UE 102 also performs a CA operation and communicates (e.g., via cell 124 and another cell(s) covered by the MeNB 104) with the MeNB 104.

In some implementations, after the UE 102 transitions to the connected state upon completion of either the RRC connection establishment procedure or resume procedure, the MeNB 104 can perform a DC configuration procedure with the SgNB 106A, to configure the UE 102 to operate in EN-DC with the RAN. After performing the DC configuration procedure, the UE 102 can communicate in EN-DC with the MeNB 104 and SgNB 106A, and indicate the more-advanced RAT supported by the RAN (i.e., 5G) on a display of the UE 102. In some implementations, as described above, the UE 102 can display different versions of the 5G indicator depending on whether the SgNB 106A operates within FR2 (e.g., 24 Ghz or higher as a mmWave base station), or within FR1 (e.g., sub-6 Ghz as a non-mmWave base station).

While scenario 500B and the accompanying descriptions refer specifically to the UE 102, MeNB 104, and SgNB 106A in the context of EN-DC, it is understood that scenario 500B can apply to other types of DC (NGEN-DC, NR-DC or NE-DC) or MC. In some implementations, the list(s) stored in the UE 102 may also indicate all the applicable RATs supported by each of the PLMNs. For example, if the base stations 104, 106A are both 5G base stations, and an additional base station in the RAN is a 6G base station, an entry in the list for the PLMN ID corresponding to the PLMN that covers the three base stations may include indications of 5G and 6G, or other suitable indications. After the UE 102 registers with the PLMN with MC enabled and communicates in MC with the three base stations, the UE 102 can display indications of 5G, 6G, or both in accordance with the list. Because the UE 102 uses the list that designates all the frequency bands (or combinations thereof) supported by the UE 102 when displaying indications for the RAT(s), the UE 102 is prevented from erroneously displaying an indication of a RAT or generation of technology corresponding to a RAN when the UE 102 cannot support particular frequency bands in which the RAN operates.

FIG. 5C illustrates a scenario 500C in which the base station 104 of RAN 105 can operate as an MN and the base station 106A of RAN 105 can operate as an SgNB for the UE 102. The UE 102 in FIG. 5C is capable of DC operation, but not necessarily capable of operating in DC on all combinations of frequency bands.

As in FIG. 5A, the UE 102 initially operates 501C in an idle or inactive state (e.g., RRC_IDLE or RRC_INACTIVE respectively) while camping on a cell (e.g., cell 124) of the MN 104, similar to event 501A. While operating 501C in the idle or inactive state, the UE 102 receives 502C system information via the cell 124 from the MN 104, similar to event 502A. The system information includes SgNB frequency information indicating a SgNB frequency band (i.e., an NR frequency band) operable by the SgNB 106A, which operates an NR carrier frequency. The SgNB frequency information can include one or more SgNB frequency band numbers indicating one or more SgNB frequency bands. The UE 102 also obtains a PLMN ID from the system information (e.g., SIB1) and registers to a PLMN to which RAN 105 belongs corresponding to the PLMN ID (e.g., by performing 466A the NAS procedure and/or RRC procedure described in event 466A of FIG. 4A). In some implementations, the UE 102 enables EN-DC before, while, or upon registering with the PLMN.

After the UE 102 registers to the PLMN, the UE 102 determines 562C whether the SgNB frequency band is included in a list stored at the UE 102 that designates all the frequency bands (or combinations thereof) supported by the UE 102.

For example, the list may designate only the frequency bands that the UE 102 has been tested against and approved to support DC. If the UE 102 determines that the SgNB frequency band is included in a DC frequency band combination list, then the UE 102 can be aware that the UE 102 supports DC with the RAN 105 (i.e., MN 104 and SgNB 106A). In some implementations, the UE 102 may obtain an indication of an MN frequency band from the system information (e.g., SIB) to determine 562C whether both the MN frequency band and the SgNB frequency band are included as one of the combinations of frequency bands in the DC frequency band combination list. The list may be dynamically updatable during an over-the-air (OTA) update.

If the UE 102 determines 562C the SgNB frequency band (and the MN frequency band if received in the event 502C) are included in the list, the UE 102 proceeds to display 576C a 5G indicator, similar to event 576B. The UE 102 can display 576C different versions of the 5G indicator depending on whether the SgNB 106A operates within FR2, e.g., 24 Ghz or higher as a mmWave base station, or within FR1, e.g., sub-6 Ghz as a non-mmWave base station. For example, if the SgNB frequency information includes an SgNB band within FR2 but not an SgNB band within FR1, and the SgNB band within FR2 is included in a DC frequency band combination list, the UE 102 can display 576C an mmWave icon or other suitable indicator that indicates that the UE 102 can communicate with an mmWave base station. As another example, if the SgNB frequency information includes an SgNB band within FR2 and an SgNB band within FR1 (but the UE 102 does not support any SgNB bands within FR2), and the SgNB band within FR1 is included in a DC frequency band combination list, the UE 102 can display 576C a non-mmWave icon or other suitable indicator that indicates that the UE 102 can communicate with a non-mmWave base station.

Otherwise, if the UE 102 determines 562C the SgNB frequency band (and the MN frequency band if received in the event 502C) are not included in the list, the UE 102 proceeds to display an indicator corresponding to the RAT of the MN 104. For example, if the UE 102 determines 563C that the MN 104 is a 5G base station (i.e., gNB), the UE 102 displays 577C a 5G indicator. If the UE determines 563C that the MN 104 is a 4G base station (i.e., eNB), the UE 102 displays 578C a 4G indicator.

In some implementations, the list described above may be associated with a PLMN ID. In such implementations, if the UE 102 determines that the obtained PLMN ID (at event 502C) is identical to the PLMN ID associated with the list, the UE 102 proceeds to event 562C. Otherwise, the UE 102 proceeds to event 563C. In other implementations, the UE 102 can store multiple lists, each associated with a unique PLMN ID, instead of a single list described above. In these implementations, if the obtained PLMN ID (event 502C) is identical to any of the PLMN IDs associated with the multiple lists, the UE 102 proceeds to event 562C. Otherwise, the UE 102 proceeds to event 563C. In some implementations, the UE 102 can indicate the RAT supported by the RAN 105 depending on the carrier frequency, frequency ranges, or frequency bands over which the UE 102 transitions into connected state and communicates in DC with the RAN 105. For example, the UE 102 can display different versions of the 5G indicator depending on whether the SgNB 106A operates within FR2, e.g., 24 Ghz or higher as a mmWave base station, or within FR1, e.g., sub-6 Ghz as a non-mmWave base station, as discussed above. The MN 104 may broadcast the PLMN ID and the SgNB frequency information in the same SIB or different SIBs.

To transition into connected state, in some implementations, the UE 102 can perform an RRC connection establishment procedure or an RRC resume procedure with the MN 104. After performing the RRC connection establishment or the resume procedure, the UE 102 can communicate in SC with the MN 104 via cell 124 and indicate the RAT supported by the MN 104 on a display of the UE 102.

In some implementations, after the UE 102 transitions to the connected state upon completion of either the RRC connection establishment procedure or resume procedure, the MN 104 can perform a DC configuration procedure with the SgNB 106A, to configure the UE 102 to operate in DC with the RAN. After performing the DC configuration procedure, the UE 102 can communicate in DC with the MN 104 and SgNB 106A, and indicate the more-advanced RAT supported by the RAN (i.e., 5G or other version of the 5G indicator as described above) on a display of the UE 102.

While scenario 500C and the accompanying descriptions refer specifically to the UE 102, MN 104, and SgNB 106A in the context of DC, it is understood that scenario 500C can apply to other types of MC. In some implementations, the list(s) stored in the UE 102 may also indicate all the applicable RATs supported by each of the PLMNs. For example, if the base stations 104, 106A are both 5G base stations, and an additional base station in the RAN is a 6G base station, an entry in the list for the PLMN ID corresponding to the PLMN that covers the three base stations may include indications of 5G and 6G, or other suitable indications. After the UE 102 registers with the PLMN with MC enabled and communicates in MC with the three base stations, the UE 102 can display indications of 5G, 6G, or both in accordance with the list. Because the UE 102 uses the list that designates all the frequency bands (or combinations thereof) supported by the UE 102 when displaying indications for the RAT(s), the UE 102 is prevented from erroneously displaying an indication of a RAT or generation of technology corresponding to a RAN when the UE 102 cannot support particular frequency bands in which the RAN operates.

FIG. 6 illustrates a scenario 600 in which the base station 104 and the UE 102 can communicate using CA via a plurality of cells covered by the BS 104. The UE 102 in FIG. 6A is capable of CA operation, but not necessarily capable of operating in CA on all combinations of frequency bands operable by the plurality of cells. In some implementations, the BS 104 can operate as an MN for the UE 102.

As in FIG. 5A, the UE 102 initially operates 601 in an idle or inactive state (e.g., RRC_IDLE or RRC_INACTIVE respectively) while camping on a cell (e.g., cell 124) of the BS 104, similar to event 501A. While operating 601 in the idle or inactive state, the UE 102 receives 602 system information via the cell 124 from the BS 104, similar to event 502A. For example, the system information (e.g., a new or existing SIB) includes in indication that UEs in the cell 124 have entered a coverage area that offers 5G capabilities (e.g., CA in one or more low NR frequencies and/or high NR frequencies). The system information can also include CA frequency information indicating a CA frequency band operable by the BS 104, which operates at least one carrier frequency within the CA frequency band. The CA frequency information can include one or more CA frequency band numbers indicating one or more CA frequency bands. The UE 102 also obtains a PLMN ID from the system information (e.g., SIB1) and registers to a PLMN to which the BS 104 belongs corresponding to the PLMN ID (e.g., by performing 466A the NAS procedure and/or RRC procedure described in event 466A of FIG. 4A). In some implementations, the UE 102 enables CA before, while, or upon registering with the PLMN.

After the UE 102 registers to the PLMN, the UE 102 determines 662 whether the CA frequency band is included in a list stored at the UE 102 that designates all the frequency bands (or combinations thereof) supported by the UE 102.

For example, the list may designate only the frequency bands that the UE 102 has been tested against and approved to support CA. If the UE 102 determines that the CA frequency band is included in a CA frequency band combination list, then the UE 102 can be aware that the UE 102 supports CA with the BS 104. In some implementations, the UE 102 may determine 662 whether both the band of a serving cell (i.e., cell 124) and the CA frequency band are included as one of the combinations of frequency bands in the CA frequency band combination list. The list may be dynamically updatable during an over-the-air (OTA) update.

If the UE 102 determines 662 the CA frequency band is included in the list, the UE 102 proceeds to display 676 a first icon or indicator. The first icon (e.g., “CA”, “+”) can indicate that the UE 102 can communicate in CA with the BS 104. In some implementations, the first icon may also indicate the RAT operable by the BS 104. For example, if the BS 104 is an eNB, the UE 102 also displays 676 a 4G icon with the first icon (e.g., “4G+”). If the BS 104 is a gNB, the UE 102 displays 676 a 5G icon with the first icon (e.g., “5G+”). If the BS 104 is a 6G base station, the UE 102 displays 676 a 6G icon with the first icon (e.g., “6G+”). In some implementations, the UE 102 can display 676 different versions of the first icon depending on whether the CA frequency band is within a FR2, e.g., 24 Ghz or higher, or within a FR1, e.g., sub-6 Ghz. For example, if the CA frequency information includes a CA frequency band within FR2 but not within FR1, and the CA frequency band within FR2 is included in a CA frequency band combination list, the UE 102 can display 576 an mmWave icon or other suitable indicator that indicates that the UE 102 can communicate with an mmWave base station. As another example, if the CA frequency information includes an CA frequency band within FR2 and within FR1 (but the UE 102 does not support any CA frequency bands within FR2 according to the CA frequency band combination list), and the CA frequency band within FR1 is included in a CA frequency band combination list, the UE 102 can display 676 a non-mmWave icon or other suitable icon that indicates that the UE 102 can communicate with a non-mmWave base station.

Otherwise, if the UE 102 determines 662 the CA frequency band is not included in the list, the UE 102 proceeds to display 677 a second icon. The second icon can indicate that the UE 102 cannot communicate in CA with the BS 104. In some implementations, the second icon may indicate the RAT operable by the BS 104. For example, if the BS 104 is an eNB, the UE 102 displays 677 a 4G icon (e.g., “4G”). If the BS 104 is a gNB, the UE 102 displays 677 a 5G icon (e.g., “5G”). If the BS 104 is a 6G base station, the UE 102 displays 677 a 6G icon (e.g., “6G”).

In some implementations, the list described above may be associated with a PLMN ID. In such implementations, if the UE 102 determines that the obtained PLMN ID (at event 602) is identical to the PLMN ID associated with the list, the UE 102 proceeds to event 662. Otherwise, the UE 102 proceeds to event 663. In other implementations, the UE 102 can store multiple lists, each associated with a unique PLMN ID, instead of a single list described above. In these implementations, if the obtained PLMN ID (event 602) is identical to any of the PLMN IDs associated with the multiple lists, the UE 102 proceeds to event 662. Otherwise, the UE 102 proceeds to event 663. The BS 104 may broadcast the PLMN ID and the CA frequency band information in the same SIB or different SIBs. In some implementations, the UE 102 can indicate the RAT supported by the RAN depending on the carrier frequency, frequency ranges, or frequency bands over which the UE 102 transitions into connected state and communicates in CA with the RAN. For example, the UE 102 can display different versions of the first icon depending on whether the BS 104 operates within FR2, e.g., 24 Ghz or higher as a mmWave base station, or within FR1, e.g., sub-6 Ghz as a non-mmWave base station, as discussed above.

To transition into connected state, in some implementations, the UE 102 can perform an RRC connection establishment procedure or an RRC resume procedure with the BS 104. After performing the RRC connection establishment or the resume procedure, the UE 102 can communicate in CA with the BS 104 via cell 124 and other cells covered by the BS 104, and indicate the RAT supported by the BS 104 on a display of the UE 102.

Referring next to FIG. 7, according to a scenario 700, the base station 104 (e.g., MN 104, MeNB 104) generates SN frequency information based on information received from base station 106A (e.g., SN 106A, SgNB 106A), and broadcasts the SN frequency information to the UE 102, as described in various implementations of events 402B, 502A, 502B, and 502C.

Initially, the SN 106A sends 712 a first interface message including first served cell information to the MN 104. In some implementations, the first served cell information includes first SN frequency information for first cell(s) served by the SN 106A. The first SN frequency information includes DL frequency information and/or UL frequency information for the first cell(s). The DL and/or UL frequency information can include channel number(s) and/or band number(s). The first served cell information can include cell identity/identities (e.g., physical identity/identities and/or cell global identity/identities) for the first cell(s). The first served cell information can also include tracking area code(s) and/or PLMN ID(s) for the first cell(s).

After receiving the first served cell information, the MN 104 generates 716 SN frequency information from the first served cell information. In some implementations, if the SN 106A is a gNB, the first served cell information is a Served NR Cell Information IE or a Served Cell Information NR IE. If the SN 106A is an ng-eNB, the first served cell information is a Served Cell Information E-UTRA IE.

In some implementations, an additional SN, such as the SN 106B, can send 714 a second interface message including second served cell information to the MN 104. The second served cell information is similar to the first served cell information, in that the second served cell information includes second SN frequency information for second cell(s) served by the SN 106B. In such implementations, the MN 104 considers the second served cell information when generating 716 the SN frequency information. In some implementations, the MN 104 can generate the SN frequency information without referring to the second served cell information if the second served cell information is the same as the first served cell information.

In some implementations, the MN 104 generates 716 the SN frequency information including frequency band number(s) from the frequency band number(s) in the first SN frequency information and, if applicable, the second SN frequency information. In other implementations, the MN 104 generates 716 the SN frequency information including frequency band number(s) derived from channel number(s) in the first SN frequency information and, if applicable, the second SN frequency information.

In some implementations, the SN 106A sends the first interface message in response to receiving a third interface message from the MN 104 that includes MN served cell information. The SN 106A can determine the first served cell information either based on the MN served cell information, or irrespective of the MN served cell information. In such implementations, the third interface message and first interface message can be an Interface Setup Request message and an Interface Setup Response message respectively, or a Configuration Update message and a Configuration Update Acknowledge message respectively.

In other implementations, the SN 106A initiates in sending the first interface message (i.e., without receiving the third interface message from the MN 104 described above). The MN 104 can send a fourth interface message to the SN 106A in response to the first interface message. In such implementations, the first interface message and fourth interface message can be a Configuration Update message and a Configuration Update Acknowledge message respectively.

The SN 106B can determine the second served cell information and send the second interface message similar to the different ways in which the SN 106A can send the first interface message described above.

In some implementations, the Interface Setup Request message and Interface Setup Response message described above can be an EN-DC X2 Setup Request message and EN-DC X2 Setup Response message respectively, or an Xn Setup Request message and Xn Setup Response message respectively. In some implementations, the Configuration Update message and Configuration Update Acknowledge message described above can be an EN-DC Configuration Update message and an EN-DC Configuration Update Acknowledge message respectively, or an NG-RAN Node Configuration Update message and an NG-RAN Node Configuration Update Acknowledge message respectively.

After generating 716 the SN frequency information, the MN 104 broadcasts 702 system information including the SN frequency information to UEs, including the UE 102 as described in events 402B, 502A, 502B, and 502C.

In some implementations, if the SN 106A includes a CU 172 and a DU 174, the CU 172 can receive a portion or all of the first served cell information from the DU 174 and send the first served cell information to the DU 174. Similarly, if the SN 106B includes a CU 172 and a DU 174, the CU 172 can receive a portion or all of the second served cell information from the DU 174 and send the second served cell information to the DU 174.

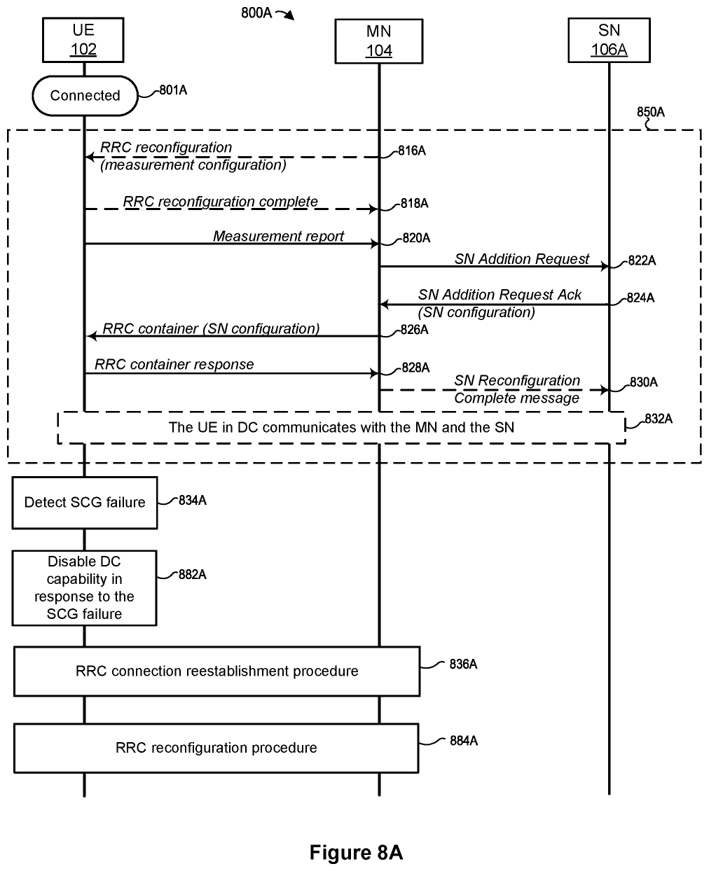

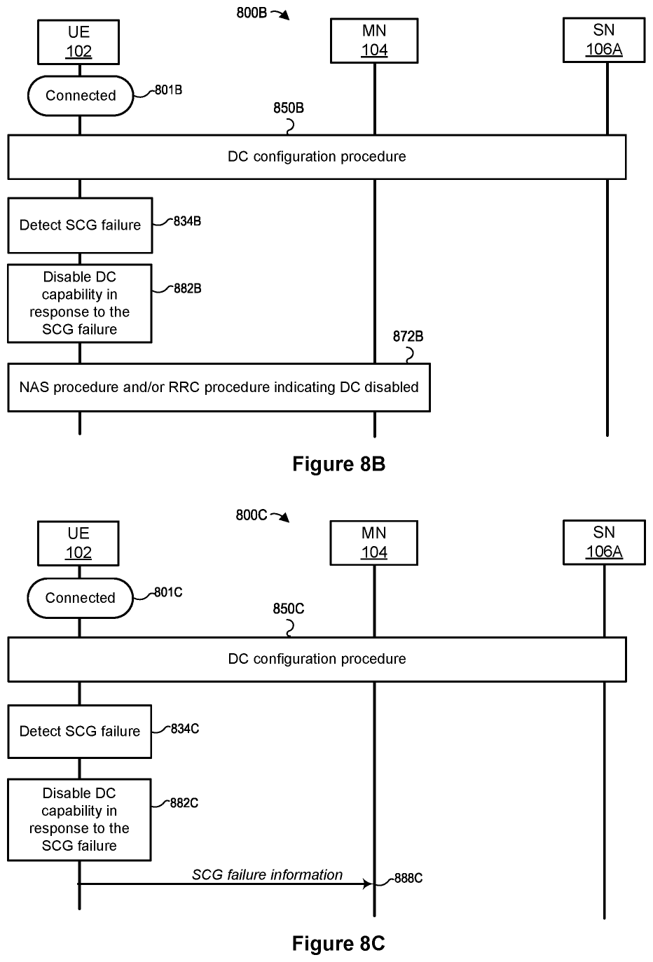

FIGS. 8A-8C correspond to scenarios in which a UE disables DC capability in response to detecting SCG failure (e.g., the UE 102 fails to recognize or parse an SN configuration, as will be further described below). While FIGS. 8A-8C and the accompanying descriptions refer to specifically to the UE 102 communicating in DC with base stations 104, 106A of FIG. 1A, it is understood that the following techniques may be implemented in scenarios related to MC or other functionalities and by other components and/or in systems other than the wireless communication system 100 of FIG. 1A. For example, a UE can disable CA capability in response to failing to recognize or parse a CA configuration received from a RAN, and in some implementations, provide an indication to the RAN that the UE cannot activate CA capability.

Referring first to FIG. 8A, in a scenario 800A, the base station 104 operates as an MN and the base station 106A operates as an SN for the UE 102.

Initially, the UE 102 operates 801A in a connected state (e.g., RRC_CONNECTED). The MN 104 performs 850A a DC configuration procedure to configure the UE 102 for DC operation (i.e., to communicate in DC with the MN 104 and SN 106A). To perform the DC configuration, in some implementations, the MN 104 can transmit 816A an RRC Reconfiguration message (e.g., a RRCConnectionReconfiguration or a RRCReconfiguration message) including a measurement configuration to the UE 102. With the measurement configuration, the MN 104 enables the UE 102 to measure a carrier frequency of the SN 106A. In response to receiving 816A the RRC Reconfiguration message, the UE 102 transmits 818A an RRC Reconfiguration Complete message (e.g., a RRCConnectionReconfigurationComplete or a RRCReconfigurationComplete message) to the MN 104.

Pursuant to the measurement configuration, the UE 102 transmits 820A at least one measurement report message to the MN 104. After receiving the measurement report message, the MN 104 sends 822A an SN Addition Request message to the SN 106A to prepare DC operation for the UE 102. In some implementations, the MN 104 determines to prepare DC for the UE 102 based on measurement result(s) included in the measurement report message(s) that are above (or below) one or more predetermined thresholds, or in response to calculating a filtered result from the measurement results that is above (or below) a predetermined threshold. In response to receiving the SN Addition Request message, the SN 106A sends 824A an SN Addition Request Acknowledge message including an SN configuration to the MN 104, which in turn transmits 826A an RRC Container message including the SN configuration to the UE 102. In response, the UE 102 transmits 828A an RRC Container Response message to the MN 104, which in turn sends 830A an SN Reconfiguration Complete message to the SN 106A to indicate that the UE 102 received the SN configuration. In some implementations, the SN configuration can be an SN RRC Reconfiguration message (e.g., RRCReconfiguration message), and the UE 102 can include an SN RRC Reconfiguration Complete message (e.g., RRCReconfigurationComplete message) in the RRC Container Response message. The MN 104 can include the SN RRC Reconfiguration Complete message in the SN Reconfiguration Complete message at event 830A.

In some implementations and scenarios in which the UE 102 does not detect a communication failure (i.e., SCG failure) with the SN 106A via a SCG covered by the SN 106 after receiving 826A the SN configuration, the UE 102 in DC may communicate 832A with the MN 104 and SN 106A by using configuration parameters in the SN configuration. In some implementations, the UE 102 may perform a random access procedure with the SN 106A according to one or more random access configuration parameters in the SN configuration. After the SN 106A identifies the UE 102 in the random access procedure, the SN 106A communicates data (e.g., UL PDU and/or DL PDU) with the UE 102 at event 832A. The events 816A, 818A, 820A, 822A, 824A, 826A, 828A, 830A, and if applicable, 832A are collectively referred to in FIG. 8A as a DC configuration procedure 850A.

However, as described above, if the UE 102 is not inter-operable with the SN 106A, the UE 102 may not properly communicate with the SN 106A, despite the UE 102 having DC capability. Thus, the UE 102 detects 834A SCG failure when the UE 102 fails to recognize or parse the SN configuration received in event 826A, for example, or otherwise fails to communicate with the SN 106A. This drawback is exacerbated if the MN 104 continues to select the SN 106 (or other SNs unsupported by the UE 102) to coordinate DC operations for the UE 102, which results in the UE 102 continuously detecting SCG failure.

To avoid these issues, in response to detecting 834A the SCG failure, the UE 102 disables 882A DC capability. As a result, the UE 102 stops measuring a carrier frequency of the SN 106A, stops sending a measurement report message to the MN 104 to prevent the MN 104 from selecting SN 106A for a DC operation with the UE 102, or otherwise stops attempting to communicate with the SN 106A. In some implementations, the UE 102 may disable 882A DC capability after the UE 102 detects a certain number M of SCG failures, where M≥1. The UE 102 may be preconfigured with the value of M to track the number of SCG failures, for example.

In some implementations, the UE 102 performs 836A an RRC connection reestablishment procedure with the MN 104 in response to detecting 834A the SCG failure. In some implementations, to perform the RRC connection reestablishment procedure, the UE 102 transmits an RRC Reestablishment Request message to the MN 104, which in turn transmits an RRC Reestablishment message to the UE 102. In response, the UE 102 transmits an RRC Reestablishment Complete message to the MN 104.

Because the UE 102 disabled DC capability at event 882A, the MN 104 is prevented from performing another DC configuration procedure (similar to DC configuration procedure 850A) with the UE 102 after completing the RRC connection reestablishment procedure with the UE 102. Therefore, the UE 102 and the RAN advantageously do not enter into an indefinite and continuous loop of performing a DC configuration procedure, detecting SCG failure, and performing a RRC connection reestablishment procedure with the MN 104 due to the SCG failure.

In some implementations, the MN 104 can perform 884A an RRC connection reconfiguration procedure with the UE 102 after performing 836A the RRC connection reestablishment procedure (e.g., after receiving the RRC Reestablishment message or the RRC Reestablishment Complete message). In some implementations, to perform the RRC connection reconfiguration procedure, the MN 104 transmits an RRC Reconfiguration message to the UE 102, which in response transmits an RRC Reconfiguration Complete message to the MN 104. The RRC Reconfiguration message can include a measurement configuration, so that the UE 102 is enabled to transmit at least one measurement report message including measurement result(s) of a carrier frequency of SN 106A to the MN 104, pursuant to the measurement configuration. However, in response to the UE 102 disabling 882A DC capability (or while the UE 102 has DC capability already disabled), the UE 102 refrains from transmitting the measurement report message(s) or from otherwise measuring the carrier frequency of SN 106A. Thus, the MN 104 is prevented from sending an SN Addition Request message to the SN 106A. In some implementations, in disabling 882A DC capability, the UE 102 switches off a receiver used to measure the carrier frequency of the SN 106A, or sets the receiver in a low power consumption state, to prevent the receiver from measuring the carrier frequency of the SN 106A.

In some implementations, the UE 102 may re-enable DC capability after events 836A and/or 884A. In some implementations, the UE 102 may re-enable DC capability if the UE 102 registers onto a PLMN or tracking area different than the one to which the MN 104 and/or SN 106A belongs, by performing a NAS procedure (e.g., Attach procedure, a TAU procedure, or a Registration procedure).

If the MN 104 is an eNB, the RRC Reestablishment Request message, RRC Reestablishment message, and RRC Reestablishment Complete are RRCConnectionReestablishmentRequest message, RRCConnectionReestablishment message, and RRCConnectionReestablishmentComplete message, respectively. If the MN 104 is an gNB, the RRC Reestablishment Request message, RRC Reestablishment message, and RRC Reestablishment Complete are RRCReestablishmentRequest message, RRCReestablishment message, and RRCReestablishmentComplete message, respectively.

If the MN 104 is an eNB, the RRC Reconfiguration message and RRC Reconfiguration Complete are RRCConnectionReconfiguration message and RRCConnectionReconfigurationComplete message, respectively. If the MN 104 is an gNB, the RRC Reconfiguration message and RRC Reconfiguration Complete are RRCReconfiguration message and RRCReconfigurationComplete message, respectively.

FIG. 8B illustrates a scenario 800B similar to the scenario 800A of FIG. 8A, in which the base station 104 operates as an MN and the base station 106A operates as an SN for the UE 102. Whereas the UE 102 in FIG. 8A performs an RRC reconnection establishment procedure and RRC connection reconfiguration procedure with the MN 104 in response to disabling DC capability, the UE 102 in FIG. 8B instead performs a NAS procedure and/or an RRC procedure indicating DC capability is disabled.

As in FIG. 8A, the UE 102 initially operates 801B in a connected state, the MN 104 performs 850B a DC configuration procedure with the UE 102, the UE 102 detects 834B SCG failure, and in response, the UE 102 disables 882B DC capability, similar to events 801A, 850A, 834A, and 882A, respectively.

In response to or while disabling DC capability, the UE 102 performs 872B a NAS procedure and/or RRC procedure with the MN 104 to indicate that DC capability is disabled, similar to the event 472B. After completing the NAS procedure and/or the RRC procedure, the MN 104 is prevented from performing another DC configuration procedure (similar to DC configuration procedure 850B) with the UE 102 because the UE 102 disabled DC capability at event 882B.

In some scenarios, the UE 102 may transition to operating in an idle state (e.g., RRC_IDLE) in response to detecting 834B the SCG failure, and then perform an RRC connection establishment procedure to transition back to operating in the connected state. After transitioning back to operating in the connected state, the UE 102 performs 872B the NAS procedure and/or RRC procedure. In other scenarios, the UE 102 may stay in the connected state in response to detecting 834B the SCG failure. The UE 102 then may perform an RRC connection reestablishment procedure with the MN 104, as described in event 836A, and an RRC connection reconfiguration procedure with the MN 104, as described in event 884A. After performing the RRC connection reestablishment procedure or the RRC reconfiguration procedure, the UE 102 may then perform 872B the NAS procedure and/or RRC procedure.

FIG. 8C illustrates a scenario 800C similar to the scenario 800A of FIG. 8A, in which the base station 104 operates as an MN and the base station 106A operates as an SN for the UE 102. Whereas the UE 102 in FIG. 8A performs an RRC reconnection establishment procedure and RRC connection reconfiguration procedure with the MN 104 in response to disabling DC capability, the UE 102 in FIG. 8C instead transmits an SCG Failure Information message to the MN 104.

As in FIG. 8A, the UE 102 initially operates 801C in a connected state, the MN 104 performs 850C a DC configuration procedure with the UE 102, the UE 102 detects 834C SCG failure, and in response, the UE 102 disables 882C DC capability, similar to events 801A, 850A, 834A, and 882A, respectively.

In response to or while disabling DC capability, the UE 102 transmits 888C an SCG Failure Information message (e.g., SCGFailureInformation, SCGFailureInformationEUTRA or SCGFailureInformationNR) to the MN 104 to indicate that DC capability is disabled. Thus, the MN 104 is prevented from performing another DC configuration procedure (similar to DC configuration procedure 850C) with the UE 102.

In some implementations, the UE 102 transmits 888C the SCG failure information depending on a failure type of the SCG failure or depending on a scenario where the UE 102 detects the SCG failure. In some implementations, the UE 102 transmits 888C the SCG failure information when the UE 102 is unable to comply with a configuration parameter in an RRC Reconfiguration message received from the SN 106A directly (e.g., on a SRB3) during the DC configuration procedure 850C.

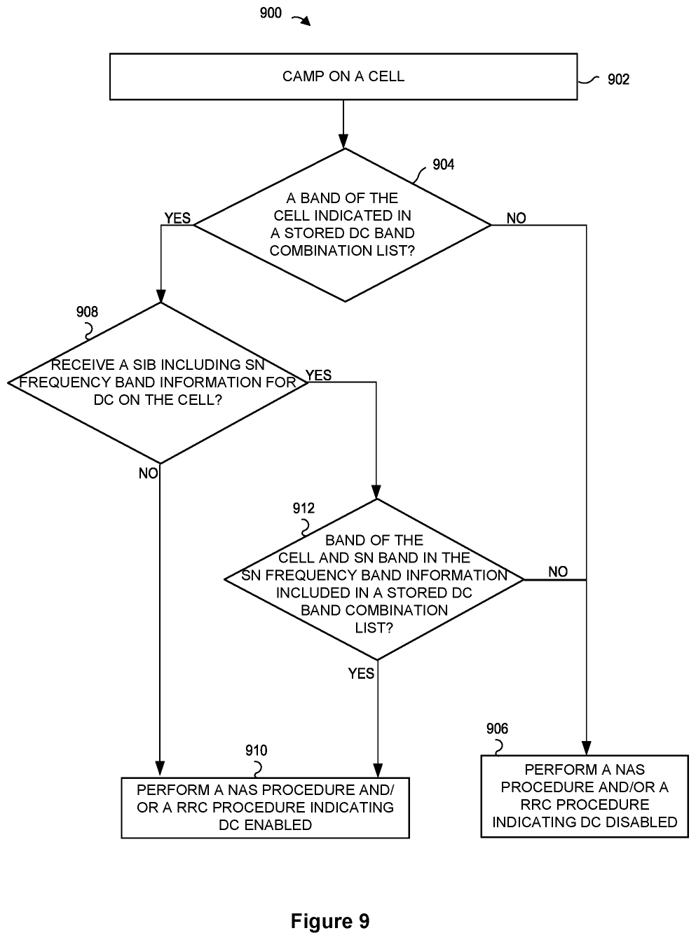

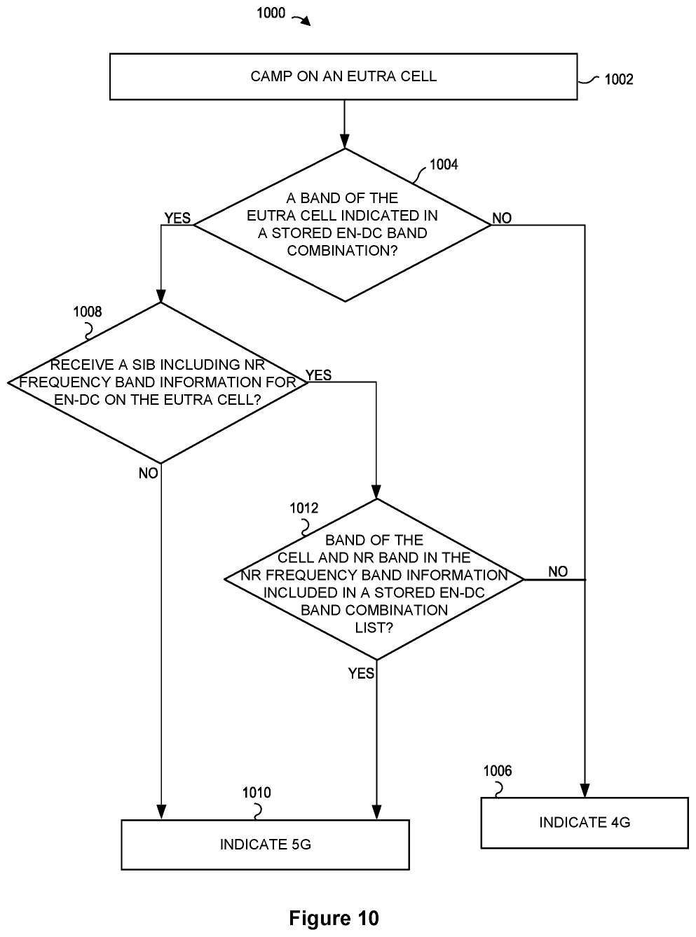

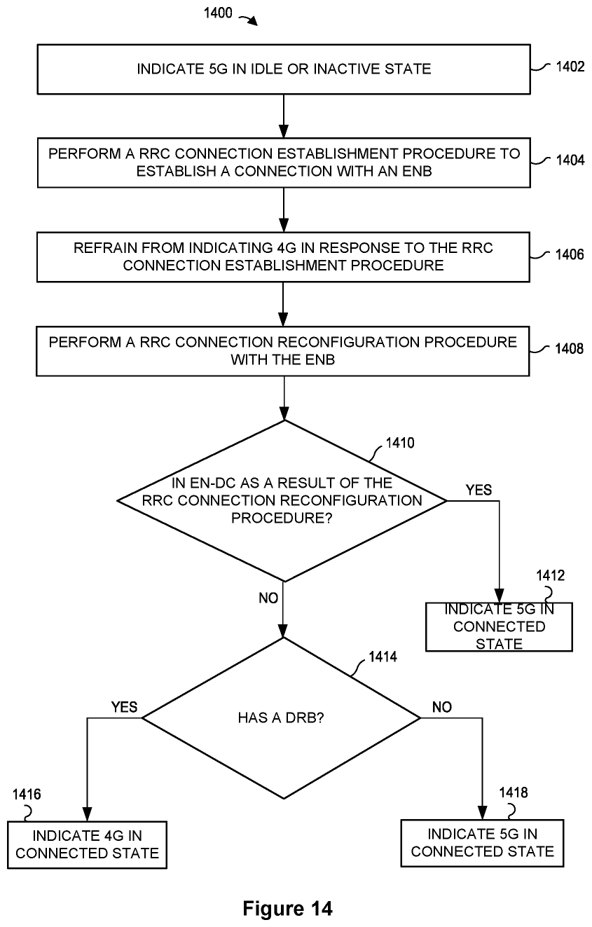

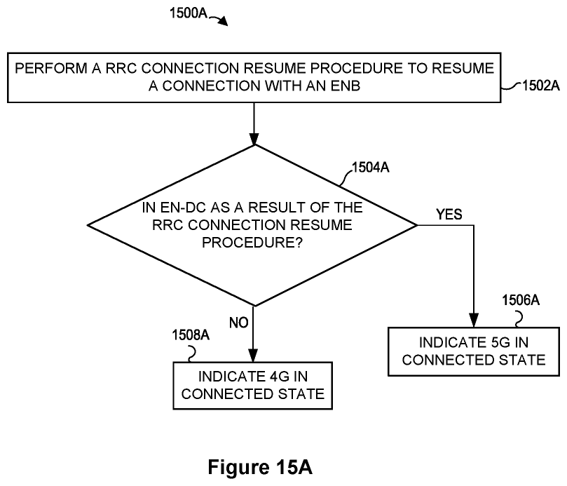

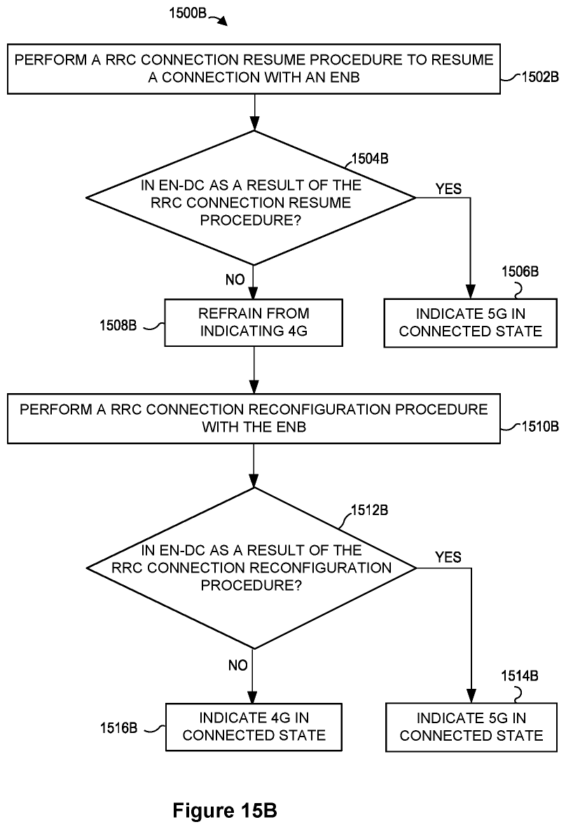

FIG. 9 corresponds to a flow diagram in which a UE enables or disables DC capability in view of information broadcasted from a RAN. FIGS. 10, 11, 12, 13A, and 13B correspond to flow diagrams in which a UE in idle or inactive state indicates a 4G icon or 5G icon (e.g., on a user interface of the UE) in view of information broadcasted from a RAN. FIGS. 14, 15A, and 15B correspond to flow diagrams in which a UE in connected state indicates a 4G icon or 5G icon. While FIGS. 9, 10, 11, 12, 13A, 13B, 14, 15A, and 15B and the accompanying descriptions refer specifically to the UE 102 and base stations 104, 106A of FIG. 1A supporting DC or CA pursuant to 5G, it is understood that the following techniques may be implemented by other components and/or in systems other than the wireless communication system 100 of FIG. 1A to support other functionalities pursuant to other technologies, such as 6G radio access and/or 6G core network, for example.

Referring first to FIG. 9, an example method 900 can be implemented in a user device (e.g., UE 102) for enabling or disabling DC capability in view of information broadcasted from a RAN. The RAN (e.g., RAN 105) can include an MN (e.g., MN 104) and an SN (e.g., SN 106A).

At block 902, a user device camps on a cell (e.g., cell 124) of the MN while operating in an idle or inactive state (e.g., in event 401B).

At block 904, the user device obtains an indication of a frequency band of the cell (i.e., the MN frequency band) from system information broadcasted by the MN, and determines whether the MN frequency band is included in a DC frequency band combination list stored at the user device that designates all the frequency bands (or combinations thereof) supported by the user device (e.g., in event 463B).

If the user device determines at block 904 the MN frequency band is not included in the DC frequency band combination list, the user device at block 906 performs a NAS procedure and/or RRC procedure to indicate to the MN that the user device disabled DC capability (e.g., in event 472B). Otherwise, if the user device determines at block 904 the MN frequency band is included in the DC frequency band combination list, the user device at block 908 determines whether the user device obtained, from the system information (e.g., SIB), SN frequency band information indicating the SN frequency band operable by the SN.

If the user device determines at block 908 that the system information did not include SN frequency band information, the user device at block 910 performs a NAS procedure and/or RRC procedure to indicate to the MN that the user device enabled DC capability (e.g., in event 466B). Otherwise, if the user device determines at block 908 that the system information includes SN frequency band information, the user device at block 912 determines whether the SN frequency band is also included as one of the combinations of frequency bands in the DC frequency band combination list (e.g., in event 463B). In this way, the user device can be prevented from enabling DC capability if both the MN frequency band and SN frequency band are not identified as one of the combinations of frequency bands in the DC frequency band combination list.

If the user device at block 912 determines that the SN frequency band is not included as one of the combinations of frequency bands in the DC frequency band combination list (e.g., event 562C), the user device at block 906 performs a NAS procedure and/or RRC procedure to indicate to the MN that the user device disabled DC capability (e.g., in event 472B). Otherwise, if the user device determines at block 912 that the SN frequency band is included as one of the combinations of frequency bands in the DC frequency band combination list, the user device at block 910 performs a NAS procedure and/or RRC procedure to indicate to the MN that the user device enabled DC capability (e.g., in event 466B).

FIG. 10 is a flow diagram depicting an example method 1000 implemented in a user device (e.g., UE 102) for indicating (e.g., displaying) a 4G icon or 5G icon in view of information broadcasted from a RAN. The RAN (e.g., RAN 105) can include an MN (e.g., MeNB 104) and an SN (e.g., SgNB 106A).

At block 1002, a user device camps on a EUTRA cell (e.g., cell 124) of the MN while operating in an idle or inactive state (e.g., in event 501B).

At block 1004, the user device obtains an indication of a frequency band of the EUTRA cell (i.e., the EUTRA frequency band) from system information broadcasted by the MN, and determines whether the EUTRA frequency band is included in an EN-DC frequency band combination list stored at the user device that designates all the frequency bands (or combinations thereof) supported by the user device (e.g., in event 562B).

If the user device at block 1004 determines the EUTRA frequency band is not included in the EN-DC frequency band combination list, the user device at block 1006 indicates (e.g., via display) the RAT of the MN (i.e., 4G or LTE) (e.g., in event 578B, 578C). Otherwise, if the user device at block 1004 determines the EUTRA frequency band is included in the EN-DC frequency band combination list, the user device at block 1008 determines whether the user device obtained, from the system information (e.g., SIB), NR frequency band information indicating the NR frequency band operable by the SN.

If the user device at block 1008 determines that the system information did not include NR frequency band information, the user device at block 1010 indicates (e.g., via display) the RAT of the SN (i.e., 5G or NR) (e.g., in event 576B, 576C). Otherwise, if the user device at block 1008 determines that the system information includes NR frequency band information, the user device at block 1012 determines whether the NR frequency band is also included as one of the combinations of frequency bands in the EN-DC frequency band combination list (e.g., in event 562B, 562C). In this way, the user device can be prevented from enabling EN-DC capability if both the EUTRA frequency band and NR frequency band are not identified as one of the combinations of frequency bands in the EN-DC frequency band combination list.

If the user device at block 1012 determines that the NR frequency band is not included as one of the combinations of frequency bands in the EN-DC frequency band combination list, the user device at block 1006 indicates (e.g., via display) the RAT of the MN (i.e., 4G) (e.g., in event 578B, 578C). Otherwise, if the user device at block 1012 determines that the NR frequency band is included as one of the combinations of frequency bands in the EN-DC frequency band combination list, the user device at block 1010 indicates (e.g., via display) the RAT of the SN (i.e., 5G) (e.g., in event 576B, 576C).

In some implementations, RRC protocol layer 312A or 312B may indicate the RAT of the SN (e.g., 4G, LTE, 5G, or NR) to internal control layer 316 directly or indirectly (e.g., via NAS protocol layer 314A or 314B or other internal layer or module not shown in FIG. 3). The interface layer 318 can send the indication of the RAT to an application in the application platform, which displays “4G”, “LTE”, “5G” or “NR” based on the indication of the RAT.

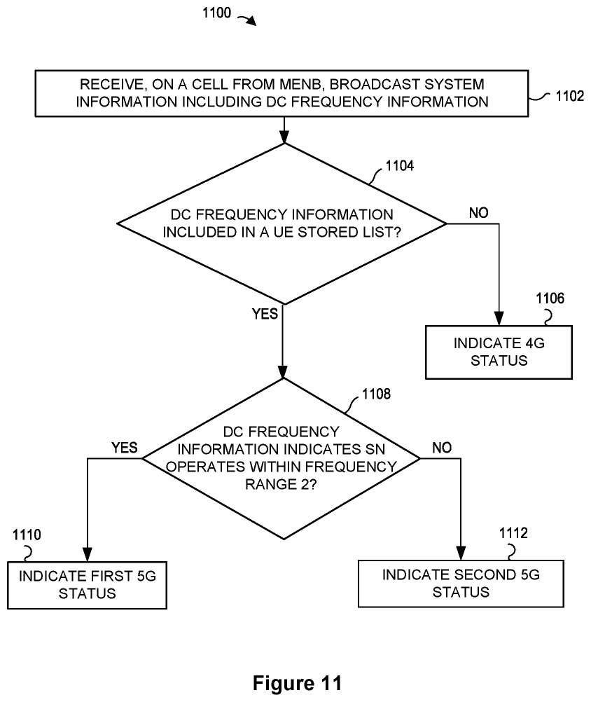

FIG. 11 is a flow diagram depicting an example method 1100 implemented in a user device (e.g., UE 102) for indicating (e.g., displaying) a 4G icon or 5G icon in view of information broadcasted from a RAN. The RAN (e.g., RAN 105) can include an MN (e.g., MeNB 104) and an SN (e.g., SgNB 106A). The user device can indicate different versions of the 5G icon depending on whether the SN operates within FR2 or FR1.

At block 1102, a user device, camped on a EUTRA cell (e.g., cell 124) of the MN while operating in an idle or inactive state, obtains DC frequency information from system information broadcasted by the MN. The DC frequency information can include a frequency band of the EUTRA cell (i.e., the EUTRA frequency band) and NR frequency band operable by the SN.

At block 1104, the user device determines whether the DC frequency information is included in an EN-DC frequency band combination list stored at the user device that designates all the frequency bands (or combinations thereof) supported by the user device (e.g., in event 562B, 562C).

If the user device determines at block 1104 the DC frequency information is not included in the EN-DC frequency band combination list, the user device at block 1106 indicates (e.g., via display) the RAT of the MN (i.e., 4G or LTE) (e.g., in event 578B, 578C). Otherwise, if the user device determines at block 1104 the DC frequency information is included in the EN-DC frequency band combination list, the user device can indicate (e.g., via display) the RAT of the SN (i.e., 5G or NR) (e.g., in event 576B, 576C).

In indicating the RAT of the SN, the user device at block 1108 can determine whether the DC frequency information indicates that the SN operates within FR2, e.g., 24 Ghz or higher as a mmWave base station, or within FR1, e.g., sub-6 Ghz as a non-mmWave base station. If the user device at block 1108 determines that the SN operates over FR2, the user device can indicate 1110 a first version of the 5G icon to indicate that the user device can communicate with an mmWave base station. Otherwise, if the user device at block 1108 determines that the SN operates over FR1, the user device can indicate 1112 a second version of the 5G icon to indicate that the user device can communicate with a non-mmWave base station.

In some implementations, RRC protocol layer 312A or 312B may indicate the RAT of the SN (e.g., 4G, LTE, 5G, NR, mmWave, non-mmWave, 5G+, NR+, 5G ultra-wideband (UWB)) to internal control layer 316 directly or indirectly (e.g., via NAS protocol layer 314A or 314B or other internal layer or module not shown in FIG. 3). The interface layer 318 can send the indication of the RAT to an application in the application platform, which displays “4G”, “LTE”, “5G”, “NR”, “5G mmWave”, “5G+”, “NR+”, or “5GUWB” based on the indication of the RAT.

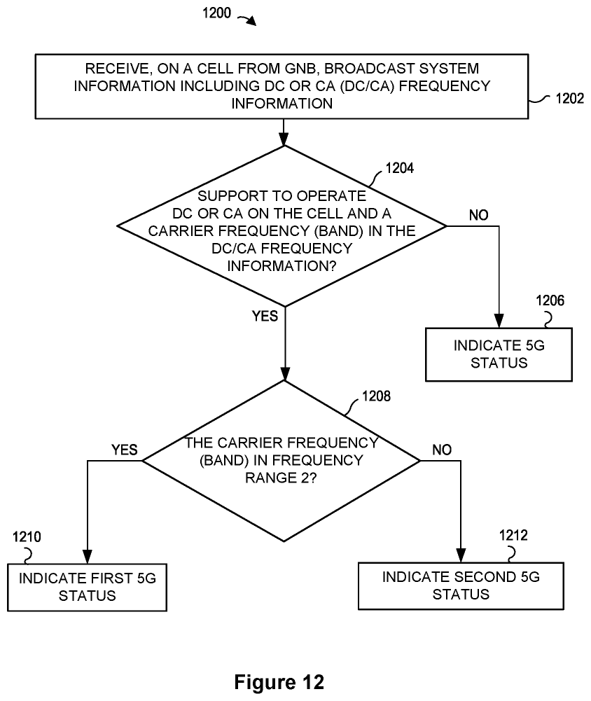

FIG. 12 is a flow diagram depicting an example method 1200 implemented in a user device (e.g., UE 102) for indicating (e.g., displaying) a 5G icon in view of information broadcasted from a base station (e.g., gNB 104). The user device can indicate different versions of the 5G icon depending on whether the base station operates within FR2 or FR1.

At block 1202, a user device, camped on a NR cell (e.g., cell 124) of the base station while operating in an idle or inactive state, obtains DC/CA frequency information from system information broadcasted by the base station. DC/CA frequency information can include an NR frequency band operable by another base station (SgNB 106A), or a CA frequency band operable by the base station (e.g., via cell 124 and other cells covered by the base station, where at least one of the cells supports NR frequencies).

At block 1204, the user device determines whether the DC/CA frequency information is included in a DC/CA frequency band combination list stored at the user device that designates all the frequency bands (or combinations thereof) supported by the user device (e.g., in events 562B, 562C, 662).

If the user device at block 1204 determines the DC/CA frequency information is not included in the DC/CA frequency band combination list, the user device at block 1206 indicates (e.g., via display) the RAT of the base station (i.e., 5G) (e.g., in events 577C, 677). Otherwise, if the user device at block 1204 determines the DC/CA frequency information is included in the DC/CA frequency band combination list, the user device at block 1208 can indicate (e.g., via display) the RAT of the base station (i.e., 5G) (e.g., in events 576B, 576C, 676) according to whether the DC/CA frequency information indicates that the base station operates within FR2, e.g., 24 Ghz or higher as a mmWave base station, or within FR1, e.g., sub-6 Ghz as a non-mmWave base station.

If the user device at block 1208 determines that the base station operates over FR2, the user device can indicate 1210 a first version of the 5G icon to indicate that the user device can communicate with an mmWave base station. Otherwise, if the user device at block 1208 determines that the base station operates over FR1, the user device can indicate 1212 a second version of the 5G icon to indicate that the user device can communicate with a non-mmWave base station.

In some implementations, RRC protocol layer 312A or 312B may indicate the RAT (e.g., 5G, NR, mmWave, non-mmWave, 5G+, NR+, 5G UWB) to internal control layer 316 directly or indirectly (e.g., via NAS protocol layer 314A or 314B or other internal layer or module not shown in FIG. 3). The interface layer 318 can send the indication of the RAT to an application in the application platform, which displays “5G”, “NR”, “5G mmWave”, “5G+”, “NR+”, or “5GUWB” based on the indication of the RAT.

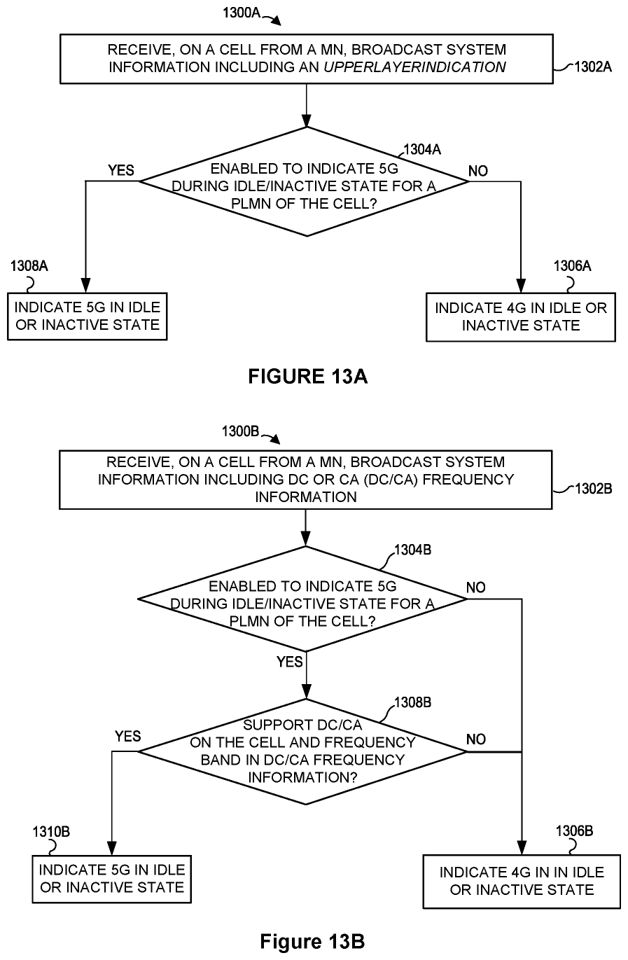

FIG. 13A is a flow diagram depicting an example method 1300A implemented in a user device (e.g., UE 102) for indicating (e.g., displaying) a 5G icon in response to receiving system information, including an upperLayerIndication field, broadcasted from an MN (e.g., MeNB 104) only if the user device is enabled to indicate the 5G icon.

At block 1302A, a user device, camped on a cell (e.g., cell 124) of the MN while operating in an idle or inactive state, obtains system information, including an upperLayerIndication field, broadcasted from the MN (e.g., in events 502A, 502B). The MN can broadcast an upperLayerIndication field to indicate to the user device that NR frequency bands are available within the area of the cell for configuration of DC operation with an SN (e.g., SgNB 106A).

Rather than automatically indicating 5G on the display while in idle or inactive state in response to receiving the upperLayerIndication field, the user device at block 1304A determines whether the user device is enabled (e.g., EN-DC capability enabled) to indicate 5G for a PLMN of the cell while in idle or inactive state. In some implementations, the user device may not be enabled to indicate 5G while in idle or inactive state, and instead, enabled to indicate 5G after the user device transitions to connected state and communicates in DC with the MN and SN over one or more NR frequencies within the NR frequency bands.

Accordingly, if the user device at block 1304A is not enabled to indicate 5G while in idle or inactive state, the user device at block 1306A indicates the RAT (e.g., 4G) supported by the MN (e.g., in events 578A, 578B) while in idle or inactive state. Otherwise, if the user device at block 1304A is enabled to indicate 5G while in idle or inactive state, the user device at block 1308A indicates 5G while in idle or inactive state (e.g., in events 576A, 576B).

FIG. 13B is a flow diagram depicting an example method 1300B implemented in a user device (e.g., UE 102) for indicating (e.g., displaying) a 5G icon in response to receiving system information, including DC/CA frequency information, broadcasted from an MN (e.g., MeNB 104) only if the user device is enabled to indicate the 5G icon.

At block 1302B, a user device, camped on a cell (e.g., cell 124) of the MN while operating in an idle or inactive state, obtains system information, including DC/CA frequency information, broadcasted from the MN (e.g., in events 502A, 502B). The MN can broadcast DC/CA frequency information to include an indication of an NR frequency band operable by an SN (SgNB 106A), or a CA frequency band operable by the MN (e.g., via cell 124 and other cells covered by the MN, where at least one of the cells supports NR frequencies), for example.

Rather than automatically indicating 5G on the display while in idle or inactive state in response to receiving the DC/CA frequency information, the user device at block 1304B determines whether the user device is enabled (e.g., EN-DC capability enabled) to indicate 5G for a PLMN of the cell while in idle or inactive state. In some implementations, the user device may not be enabled to indicate 5G while in idle or inactive state, and instead, enabled to indicate 5G after the user device transitions to connected state and communicates in DC with the MN and SN over one or more NR frequencies within the NR frequency bands.

Accordingly, if the user device at block 1304B is not enabled to indicate 5G while in idle or inactive state, the user device at block 1306B indicates a less-advanced RAT (e.g., 4G) supported by the MN while in idle or inactive state (e.g., in events 578A, 578B). Otherwise, if the user device at block 1304B is enabled to indicate 5G while in idle or inactive state, the user device at block 1308B then determines whether the NR frequency band (e.g., for DC operation with the SN) or CA frequency band indicated in the DC/CA frequency information is supported by the user device (e.g., by comparing the NR frequency band or CA frequency band with a list containing supported frequency bands, in events 562B, 562C, 662).

If the user device at block 1308B determines that the NR frequency band or CA frequency band is not supported, the user device at block 1306B indicates a less-advanced RAT (e.g., 4G) supported by the MN while in idle or inactive state (e.g., in events 578B, 578C). Otherwise, if the user device at block 1308B determines that the NR frequency band or CA frequency band is supported, the user device at block 1310B indicates 5G while in idle or inactive state (e.g., in events 576B, 576C).

FIG. 14 is a flow diagram depicting an example method 1400 implemented in a user device (e.g., UE 102) for determining whether to indicate (e.g., display) a 5G icon while in connected state, in contrast to implementations in which the user device determines whether to indicate a 5G icon while in idle or inactive state as described above in FIGS. 10, 11, 12, 13A, and 13B.

At block 1402, a user device indicates 5G while operating in an idle or inactive state (e.g., in blocks 1010, 1110, 1112, 1206, 1210, 1212, 1308A, 1308B).

Later in time, the user device can transition into the connected state (e.g., when the user device is triggered to send data, such as an outgoing phone call or browser launch). To carry out the transition, the user device at block 1404 can perform an RRC connection establishment procedure to establish a connection with a base station (e.g., eNB 104).

After the user device transitions to the connected state in response to the RRC connection establishment procedure, the user device at block 1406 refrains from indicating the RAT supported by the base station (e.g., 4G) on a display of the user device while in connected state, until the user device at block 1408 performs an RRC connection reconfiguration procedure with the base station. In this way, if the user device is configured by the base station to communicate with another base station (e.g., SgNB 106A) using a more-advanced RAT (e.g., 5G) after the RRC connection reconfiguration procedure, the user device is prevented from indicating the less-advanced RAT in the interim.

After performing the RRC connection reconfiguration procedure with the base station, the user device at block 1418 can indicate the more-advanced RAT (e.g., 5G) while in connected state if the user device at block 1410 is configured to communicate in EN-DC with the RAN (e.g., RAN 105) as a result of the RRC connection reconfiguration procedure.

If the base station did not configure the user device with EN-DC capability as a result of the RRC connection reconfiguration procedure, the user device at block 1416 can indicate the RAT supported by the base station (e.g., 4G) on a display of the user device while in connected state if the user device at block 1414 uses a radio bearer (e.g., a DRB) that terminates at the base station. However, in some implementations, even if the base station at block 1410 did not configure the user device with EN-DC capability, the user device at block 1418 may still indicate the more-advanced RAT (e.g., 5G) while in connected state if the user device at block 1414 does not yet use a radio bearer (e.g., a DRB) that terminates at the base station (e.g., until after the base station later provides a configuration parameter to the user device to configure a DRB for the user device with EN-DC capability).

In some implementations, RRC protocol layer 312A or 312B may indicate the RAT of the SgNB (e.g., 4G, LTE, 5G, NR, mmWave, non-mmWave, 5G+, NR+, 5G UWB) to internal control layer 316 directly or indirectly (e.g., via NAS protocol layer 314A or 314B or other internal layer or module not shown in FIG. 3). The interface layer 318 can send the indication of the RAT to an application in the application platform, which displays “4G”, “LTE”, “5G”, “NR”, “5G mmWave”, “5G+”, “NR+”, or “5GUWB” based on the indication of the RAT.

FIG. 15A is a flow diagram depicting an example method 1500A implemented in a user device (e.g., UE 102) for determining whether to indicate (e.g., display) a 5G icon in a connected state, in contrast to implementations in which the user device determines whether to indicate a 5G icon in idle or inactive state as described above in FIGS. 10, 11, 12, 13A, and 13B.

At block 1502A, a user device, while operating in an idle or inactive state with a base station (e.g., eNB 104), can transition into the connected state to resume a connection with the base station (e.g., when the user device is triggered to send data, such as an outgoing phone call or browser launch). To carry out the transition, the user device can perform an RRC connection resume procedure.

Some base stations may be capable of configuring EN-DC as part of the RRC connection resume procedure, and as such, the user device may be capable of operating with a more-advanced RAT (e.g., 5G). Therefore, the user device at block 1504A determines whether the base station configured the user device to communicate in EN-DC with the base station and another base station (e.g., SgNB 106A) using a more-advanced RAT (e.g., 5G) during/after the RRC connection resume procedure.

If the user device at block 1504A is configured to communicate in EN-DC, the user device at block 1506A indicates the more-advanced RAT (e.g., 5G) while in connected state. If the user device at block 1504A is not configured to communicate in EN-DC, the user device at block 1508A indicates the RAT supported by the base station (e.g., 4G) on a display of the user device while in connected state.

In some implementations, RRC protocol layer 312A or 312B may indicate the RAT of the SgNB (e.g., 4G, LTE, 5G, NR, mmWave, non-mmWave, 5G+, NR+, 5G UWB) to internal control layer 316 directly or indirectly (e.g., via NAS protocol layer 314A or 314B or other internal layer or module not shown in FIG. 3). The interface layer 318 can send the indication of the RAT to an application in the application platform, which displays “4G”, “LTE”, “5G”, “NR”, “5G mmWave”, “5G+”, “NR+”, or “5GUWB” based on the indication of the RAT.

FIG. 15B is a flow diagram depicting an example method 1500B implemented in a user device (e.g., UE 102) for determining whether to indicate (e.g., display) a 5G icon in a connected state, in contrast to implementations in which the user device determines whether to indicate a 5G icon in idle or inactive state as described above in FIGS. 10, 11, 12, 13A, and 13B.

At block 1502B, a user device, while operating in an idle or inactive state with a base station (e.g., eNB 104), can perform an RRC connection resume procedure to resume a connection with the base station, similar to block 1502A.

After performing the RRC connection resume procedure, the user device refrains from indicating the RAT supported by the base station (e.g., 4G) on a display of the user device while in connected state, because some base stations may be capable of configuring EN-DC as part of the RRC connection resume procedure, and as such, the user device may be capable of operating within a more-advanced RAT (e.g., 5G). Therefore, the user device at block 1504B determines whether the base station configured the user device to communicate in EN-DC with the base station and another base station (e.g., SgNB 106A) using a more-advanced RAT (e.g., 5G) during/after the RRC connection resume procedure, similar to block 1504A.

If the user device at block 1504B is configured to communicate in EN-DC, the user device at block 1506B indicates the more-advanced RAT (e.g., 5G) while in connected state. If the user device at block 1504B is not configured to communicate in EN-DC, the user device at block 1508B refrains from indicating the RAT supported by the base station (e.g., 4G) on a display of the user device while in connected state, unlike block 1508A. In this way, if the user device is configured by the base station to communicate with another base station (e.g., SgNB 106A) using a more-advanced RAT (e.g., 5G) after the RRC connection resume procedure, the user device is prevented from indicating the less-advanced RAT in the interim.

After performing the RRC connection resume procedure with the base station, the user device at block 1510B performs an RRC connection reconfiguration procedure with the base station. During the RRC connection reconfiguration procedure, in some implementations, the base station may configure the user device to communicate in EN-DC with the base station and another base station (e.g., SgNB 106A) using a more-advanced RAT (e.g., 5G).

If the base station configured the user device with EN-DC capability at block 1512B as a result of the RRC connection reconfiguration procedure, the user device at block 1514B can indicate the more-advanced RAT (e.g., 5G) while in connected state. Otherwise, if the base station did not configure the user device with EN-DC capability as a result of the RRC connection reconfiguration procedure, the user device at block 1516B can indicate the RAT supported by the base station (e.g., 4G) on a display of the user device while in connected state.

In some implementations, RRC protocol layer 312A or 312B may indicate the RAT of the SgNB (e.g., 4G, LTE, 5G, NR, mmWave, non-mmWave, 5G+, NR+, 5G UWB) to internal control layer 316 directly or indirectly (e.g., via NAS protocol layer 314A or 314B or other internal layer or module not shown in FIG. 3). The interface layer 318 can send the indication of the RAT to an application in the application platform, which displays “4G”, “LTE”, “5G”, “NR”, “5G mmWave”, “5G+”, “NR+”, or “5GUWB” based on the indication of the RAT.

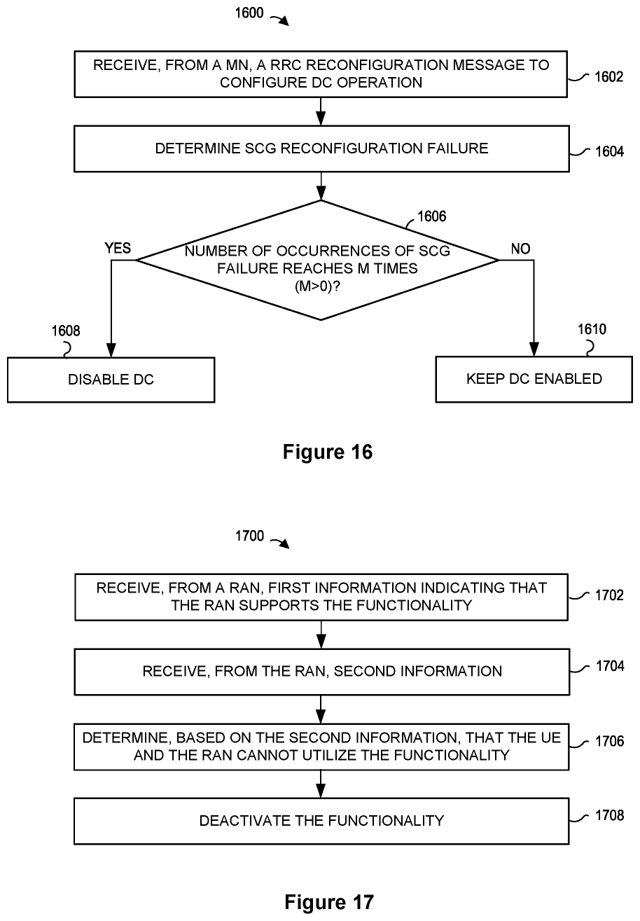

FIG. 16 is a flow diagram depicting an example method 1600 implemented in a user device (e.g., UE 102) for disabling DC capability in response to detecting SCG failure.

At block 1602, a user device receives, from an MN (e.g., MN 104), an RRC Reconfiguration message (e.g., in events 850A, 850B, 850C). The MN can transmit the RRC Reconfiguration message (e.g., a RRCConnectionReconfiguration or a RRCReconfiguration message) to the user device to configure the user device for DC operation with the MN and an SN (e.g., SN 106A) via an SCG.

At block 1604, the user device detects SCG failure after receiving the RRC Reconfiguration message (e.g., in events 834A, 834B, 834C). For example, the user device may not have been tested specifically against the SN 106A, and thus may not have been properly calibrated to communicate with the SN via the SCG.

To prevent the MN 104 from continuing to select the SN (or other unsupported SNs) to coordinate DC operations for the user device, which results in the user continuously detecting SCG failure, the user device may be configured to count the number of occurrences in which the SCG failures with the SN (or other unsupported SNs) occur. If the user device at block 1606 determines that the number of SCG failure occurrences reaches or exceeds a preconfigured value of M where M≥1, then the user device at block 1608 disables DC capability (e.g., in events 882A, 882B, 882C). Otherwise, if the user device at block 1606 determines that the number of SCG failure occurrences does not reach or exceed the preconfigured value of M, then the user device at block 1610 keeps DC capability enabled.

FIG. 17 is a flow diagram of an example method 1700 implemented in a user device (e.g., UE 102) for communicating with a RAN (e.g., RAN 105) according to a certain functionality, if the functionality is supported by both the user device and the RAN.

At block 1702, a user device that is configured to support a certain functionality for communicating with the RAN receives, from the RAN, first information indicating that the RAN supports the functionality (e.g., in events or blocks 402A, 402B, 502A, 502B, 502C, 602, 702, 816A, 850B, 850C, 904, 1004, 1104, 1202, 1302A, 1302B, 1602). In some implementations, the first information is an upper layer indication (e.g., upperLayerIndication field) associated with a PLMN that indicates if the RAN can operate MC. The user device can receive the upper layer indication in a broadcast from the RAN.

At block 1704, the user device receives, from the RAN, second information (e.g., in events or blocks 402A, 402B, 502A, 502B, 502C, 602, 702, 826A, 850B, 850C, 908, 912, 1008, 1012, 1108, 1208, 1602). In some implementations, the second information is an identifier of a PLMN to which the RAN belongs. In some implementations, the second information is a frequency band supported by the RAN. In some implementations, the second information is a configuration (e.g., an SN configuration) that indicates that the RAN, e.g., including an MN and SN, supports the functionality (e.g., DC).

At block 1706, the user device determines, based on the second information that the user device and the RAN cannot utilize the functionality (e.g., in events 462A, 463B, 562A, 562B, 562C, 662, 834A, 834B, 834C, 908, 912, 1008, 1012, 1108, 1208, 1604). In some implementations, the user device includes a stored list that indicates PLMNs and/or frequency bands supported by the user device in which the user device can utilize the functionality. Accordingly, the user device can compare the second information (e.g., PLMN identifier to which the RAN belongs, frequency band supported by the RAN) with the stored list, and if the second information is not included in the stored list, the user device determines that it cannot utilize the functionality with the RAN. In implementations in which the second information is a configuration (e.g., an SN configuration), the user device determines that it cannot utilize the functionality if the user device is unable to recognize or parse the configuration.

At block 1708, in response to the determining, the user device does not activate (e.g., deactivates, disables) the functionality (e.g., in events 470A, 470B, 578A, 578B, 577C, 578C, 677, 882A, 882B, 882C, 906, 1006, 1112, 1212, 1608).

The following description may be applied to the description above.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for handling mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

Example 1. A method in a user equipment (UE) configured to support a functionality for communicating with a radio access network (RAN), the method comprising: receiving, by one or more processors and from the RAN, first information indicating that the RAN supports the functionality; receiving, by the one or more processors and from the RAN, second information; determining, based on the second information that the UE and the RAN cannot utilize the functionality; and in response to the determining, preventing the UE from activating the functionality.

Example 2. The method of example 1, wherein receiving the second information includes: receiving, from the RAN, an identifier of a public land mobile network (PLMN) to which the RAN belongs.

Example 3. The method of example 2, wherein determining that the UE and the RAN cannot utilize the functionality further includes: comparing the identified PLMN to a list of one or more PLMNs stored at the UE.

Example 4. The method of example 3, wherein the list indicates PLMNs for which support of the functionality for the UE has been previously confirmed.

Example 5. The method of example 1, wherein receiving the second information includes: receiving, from the RAN, an indication of a frequency band supported by the RAN.

Example 6. The method of example 5, wherein determining that the UE and the RAN cannot utilize the functionality further includes: comparing the indicated frequency band to a list of frequency bands stored at the UE.

Example 7. The method of example 6, wherein the list indicates frequency bands for which support of the functionality for the UE has been previously confirmed.

Example 8. The method of example 5, wherein determining that the UE and the RAN cannot utilize the functionality includes: determining that the indicated frequency band is outside a frequency range within which the UE can activate the functionality.

Example 9. The method of example 1, wherein receiving the second information includes: receiving, from the RAN, a configuration related to the functionality.

Example 10. The method of example 9, wherein determining that the UE and the RAN cannot utilize the functionality includes: determining that the UE cannot parse the configuration.

Example 11. The method of example 10, wherein determining that the UE cannot parse the configuration includes: attempting to parse the configuration received in N instances, N>1.

Example 12. The method of any of examples 9-11, wherein the configuration is a secondary node (SN) configuration.

Example 13. The method of any of examples 9-12, further comprising: sending, to the RAN, an indication that the UE cannot activate the functionality.

Example 14. The method of any of the preceding examples, further comprising: causing a first indicator to be provided on a user interface of the UE in response to the preventing, wherein the UE provides a second indicator on the user interface when the UE activates the functionality.

Example 15. The method of example 14, wherein: the first indicator indicates a less advanced generation of technology, and the second indicator indicates a more advanced generation of technology.

Example 16. The method of any of the preceding examples, wherein receiving the first information includes receiving a broadcast from the RAN.

Example 17. The method of example 16, wherein the first information is included in a System Information Block (SIB).

Example 18. The method of example 16, wherein the first information is an upper layer indication associated with a PLMN.

Example 19. The method of any of the preceding examples, wherein the functionality is dual-connectivity (DC).

Example 20. The method of any of examples 1-18, wherein the functionality is carrier aggregation (CA).

Example 21. The UE comprising processing hardware and configured to implement a method of any of the preceding examples.

1. A method in a user equipment (UE) configured to support carrier aggregation (CA) for communicating with a radio access network (RAN), the method comprising:
receiving, by the UE and from the RAN, first information indicating that the RAN supports CA on a radio access technology (RAT);
receiving, by the UE and from the RAN, second information;
determining, by the UE and via the second information, that the UE cannot utilize a particular CA frequency band, of a plurality of CA frequency bands of the RAT, with the RAN; and
in response to the determining, disabling, by the UE, a utilization, by the UE, of the particular CA frequency band.

2. The method of claim 1, wherein the second information includes an identifier of a public land mobile network (PLMN) to which the RAN belongs.

3. The method of claim 1, wherein the second information includes an indication of a CA frequency band supported by the RAN.

4. The method of claim 3, wherein the particular CA frequency band is the indicated CA frequency band, and the determining that the UE cannot utilize the indicated CA frequency band with the RAN includes:
determining that the indicated CA frequency band is outside of a frequency range within which the UE can activate CA.

5. The method of claim 1, wherein the second information includes a configuration related to CA.

6. The method of claim 5, wherein the determining that the UE cannot utilize the particular CA frequency band with the RAN includes determining that the UE cannot parse the configuration.

7. The method of claim 6, wherein the determining that the UE cannot parse the configuration includes attempting to parse the configuration received in N instances, N>1.

8. The method of claim 1, further comprising sending, to the RAN, an indication that the UE has disabled the utilization of the particular CA frequency band.

9. The method of claim 1, further comprising:
causing a first indicator to be provided on a user interface of the UE in response to the disabling,
wherein the UE provides a second indicator on the user interface when the UE activates a subsequent utilization of the particular CA frequency band.

10. The method of claim 9, wherein:
the first indicator indicates another CA frequency band included in the plurality of CA frequency bands of the RAT, and the second indicator indicates the particular CA frequency band within Frequency Range 2.

11. The method of claim 1, wherein the receiving of the first information includes receiving a broadcast from the RAN.

12. The method of claim 11, wherein the first information is included in a System Information Block (SIB).

13. The method of claim 11, wherein the first information is an upper layer indication associated with a PLMN.

14. (canceled)

15. A UE configured to support carrier aggregation (CA) for communicating with a radio access network (RAN), the UE comprising:
a RAN interface; and
an RRC controller configured to:
receive, via the RAN interface, first information indicating that the RAN supports CA on a radio access technology (RAT);
receive, via the RAN interface, second information;
determine, via the second information, that the UE cannot utilize a particular CA frequency band, of a plurality of CA frequency bands of the RAT, with the RAN; and
in response to the determination, disable a utilization, by the UE, of the particular CA frequency band.

16. The UE of claim 15, wherein the RRC controller receives the first information via a broadcast from the RAN, and the first information is included an upper layer indication associated with a public land mobile network (PLMN) or a System Information Block (SIB) of the broadcast.

17. The UE of claim 15, wherein the second information includes an identifier of a public land mobile network (PLMN) to which the RAN belongs, an indication of a CA frequency band supported by the RAN, or a configuration related to CA.

18. The UE of claim 15, wherein the UE determines that the UE cannot utilize the particular CA frequency band with the RAN further via information related to CA stored at the UE.

19. The method of claim 1, wherein the determining is further via information that is related to CA and stored at the UE.

20. The method of claim 1, further comprising:
causing a first indicator to be provided on the user interface while the UE does not have a radio connection with RAN or while the UE has a suspended radio connection with the RAN; and
causing a second indicator to be provided on the user interface of the UE when the UE transitions into a connected state and communicates with the RAN, the second indicator indicative of a specific CA frequency band, of the plurality of CA frequency bands of the RAT, via which the UE communicates with the RAN.
